(19) United States
(12) Patent Application Publication
(10) Pub. No.: US 2026/0088963 A1
(43) Pub. Date: Mar. 26, 2026

(54) UE INITIATED SPATIAL RELATION ACTIVATION AND INDICATION

(71) Applicant: Samsung Electronics Co., Ltd., Suwon-si (KR)

(72) Inventors: Emad Nader Farag, Flanders, NJ (US); Eko Onggosanusi, Coppell, TX (US); Dalin Zhu, Allen, TX (US); Md. Saifur Rahman, Plano, TX (US)

(21) Appl. No.: 19/330,730

(22) Filed: Sep. 16, 2025

Related U.S. Application Data
(60) Provisional application No. 63/699,567, filed on Sep. 26, 2024.
(60) Provisional application No. 63/724,158, filed on Nov. 22, 2024.
(60) Provisional application No. 63/819,335, filed on Jun. 6, 2025.

(51) Int. Cl. H04L 5/00; H04W 72/232

(52) U.S. Cl. CPC H04L 5/0091; H04W 72/232

(57) ABSTRACT

Methods and apparatuses for user equipment (UE)-initiated spatial relation activation and indication. A method of operating a UE includes receiving first information related to one or more lists of transmission configuration indicator (TCI) states, receiving a list of TCI state activation times, and receiving a first channel activating N TCI states from the one or more lists of TCI states. The method further includes determining one or more activation times for the N TCI states and transmitting a second channel in response to the first channel. The second channel signals the one or more activation times for the N TCI states.

### CROSS-REFERENCE TO RELATED AND CLAIM OF PRIORITY

The present application claims priority under 35 U.S.C. § 119(e) to U.S. Provisional Patent Application No. 63/699,567 filed on Sep. 26, 2024; U.S. Provisional Patent Application No. 63/724,158 filed on Nov. 22, 2024; and U.S. Provisional Patent Application No. 63/819,335 filed on Jun. 6, 2025, which are hereby incorporated by reference in their entirety.

### TECHNICAL FIELD

The present disclosure relates generally to wireless communication systems and, more specifically, the present disclosure relates to methods and apparatuses for user equipment (UE)-initiated spatial relation activation and indication.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated spatial relation activation and indication.

In one embodiment, a user equipment (UE) is provided. The UE includes a transceiver configured to receive first information related to one or more lists of transmission configuration indicator (TCI) states, receive a list of TCI state activation times, and receive a first channel activating N TCI states from the one or more lists of TCI states. The UE further includes a processor operably coupled to the transceiver. The processor is configured to determine one or more activation times for the N TCI states. The transceiver is further configured to transmit a second channel in response to the first channel. The second channel signals the one or more activation times for the N TCI states.

In another embodiment, a base station (BS) is provided. The BS includes a processor and a transceiver operably coupled to the processor. The transceiver is configured to transmit first information related to one or more lists of TCI states, transmit a list of TCI state activation times, transmit a first channel activating N TCI states from the one or more lists of TCI states, and receive a second channel in response to the first channel. The second channel signals one or more activation times for the N TCI states.

In yet another embodiment, a method of operating a UE is provided. The method includes receiving first information related to one or more lists of TCI states, receiving a list of TCI state activation times, and receiving a first channel activating N TCI states from the one or more lists of TCI states. The method further includes determining one or more activation times for the N TCI states and transmitting a second channel in response to the first channel. The second channel signals the one or more activation times for the N TCI states.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates examples of higher layer signaling according to embodiments of the present disclosure;

FIGS. 8A, 8B, and 8C illustrate examples of spatial resource unit set configurations according to embodiments of the present disclosure;

FIG. 9 illustrates a timeline for indicating/activating a spatial resource unit according to embodiments of the present disclosure;

FIG. 10 illustrates examples of spatial resource units according to embodiments of the present disclosure;

FIG. 11 illustrates a timeline for indicating/activating a spatial resource unit according to embodiments of the present disclosure;

FIG. 12 illustrates examples of spatial resource units according to embodiments of the present disclosure;

FIG. 13 illustrates a timeline for activating transmission configuration indication (TCI) states according to embodiments of the present disclosure;

FIG. 14 illustrates a timeline for activating TCI states according to embodiments of the present disclosure;

FIG. 15 illustrates examples of TCI states in sub-lists according to embodiments of the present disclosure;

FIG. 16 illustrates an example radio access network (RAN) protocol stack according to embodiments of the present disclosure;

FIG. 17 illustrates example functional split points/options according to embodiments of the present disclosure;

FIG. 18 illustrates example functional split points/options according to embodiments of the present disclosure;

FIG. 19 illustrates an example synchronization signal/physical broadcast channel (SS/PBCH) block according to embodiments of the present disclosure;

FIG. 20A illustrates a flowchart of an example contention based random access (CBRA) procedure according to embodiments of the present disclosure;

FIG. 20B illustrates a flowchart of an example contention free random access (CFRA) procedure according to embodiments of the present disclosure;

FIG. 21A illustrates a flowchart of an example CBRA procedure according to embodiments of the present disclosure;

FIG. 21B illustrates a flowchart of an example CFRA procedure according to embodiments of the present disclosure;

FIG. 22 illustrates examples of a UE moving on a trajectory located in co-located and distributed port groups (PGs) according to embodiments of the present disclosure;

FIG. 23 illustrates examples of coherent joint transmission (CJT) coordination sets according to embodiments of the present disclosure;

FIG. 24 illustrates examples of coherent joint transmission (CJT) coordination sets across TRPs according to embodiments of the present disclosure;

FIG. 25 illustrates an example system for UE switching/connecting to a different remote unit (RU) according to embodiments of the present disclosure;

FIG. 26 illustrates an example system for serving cells according to embodiments of the present disclosure;

FIG. 27 illustrates an example of UE mobility according to embodiments of the present disclosure;

FIG. 28 illustrates examples of reference signal configurations according to embodiments of the present disclosure;

FIG. 29 illustrates examples of reference signal set configurations according to embodiments of the present disclosure;

FIG. 30 illustrates a timeline for CSI CJT reporting according to embodiments of the present disclosure; and

FIG. 31 illustrates an example method performed by a UE in a wireless communication system according to embodiments of the present disclosure.

### DETAILED DESCRIPTION

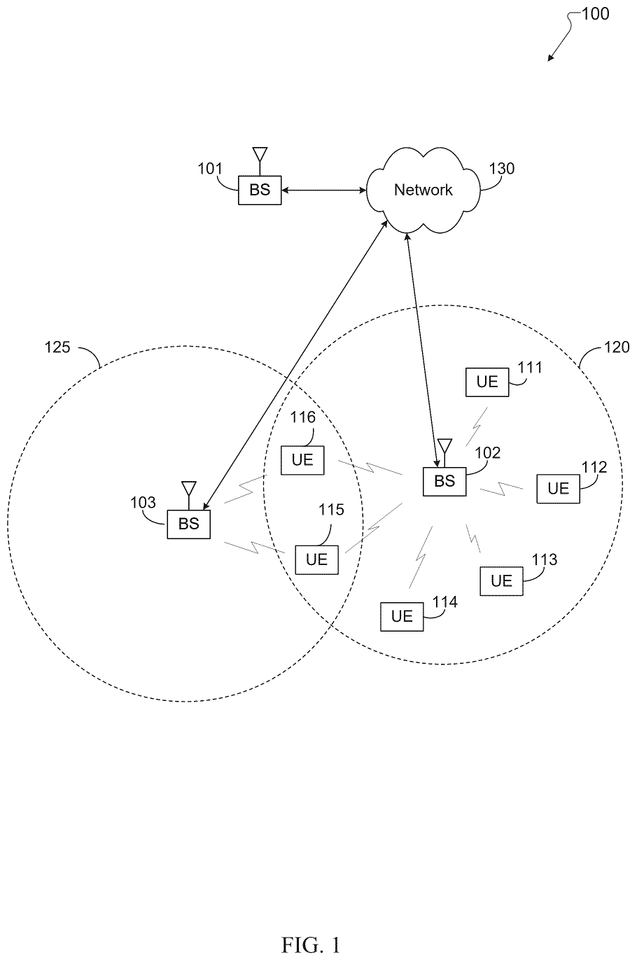

FIGS. 1-31, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 38.211 v18.4.0, “NR; Physical channels and modulation;” [REF 2]3GPP TS 38.212 v18.4.0, “NR; Multiplexing and Channel coding;” [REF 3]3GPP TS 38.213 v18.4.0, “NR; Physical Layer Procedures for Control;” [REF 4]3GPP TS 38.214 v18.4.0, “NR; Physical Layer Procedures for Data;” [REF 5]3GPP TS 38.321 v18.3.0, “NR; Medium Access Control (MAC) protocol specification;” and [REF 6]3GPP TS 38.331 v18.3.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the ULE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing UE-initiated spatial relation activation and indication. In certain embodiments, one or more of the BSs 101-103 include circuitry, programing, or a combination thereof to support UE-initiated spatial relation activation and indication.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

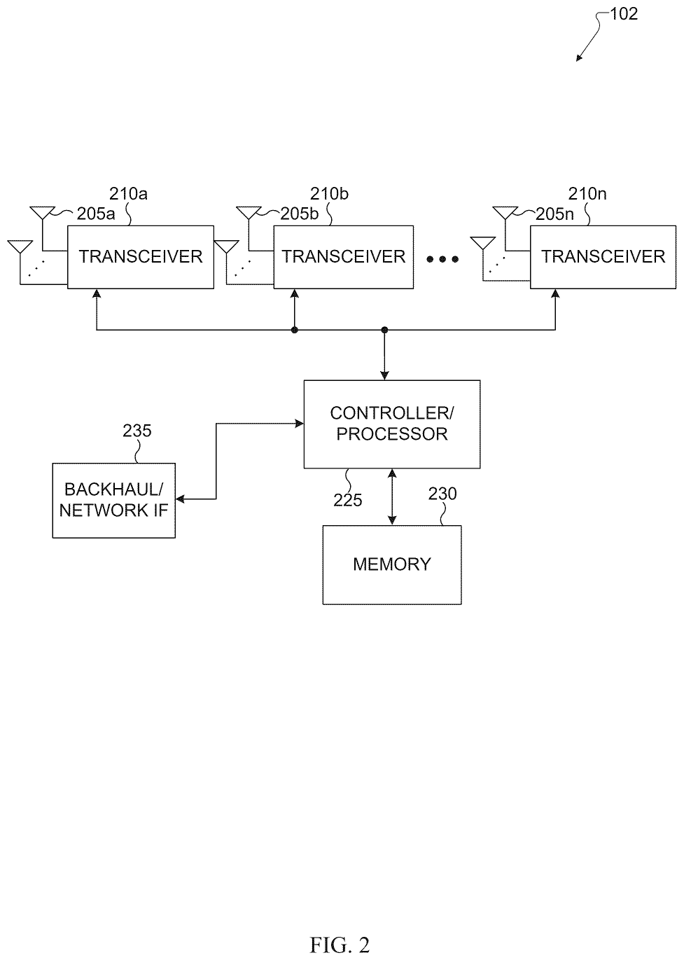

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting UE-initiated spatial relation activation and indication. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

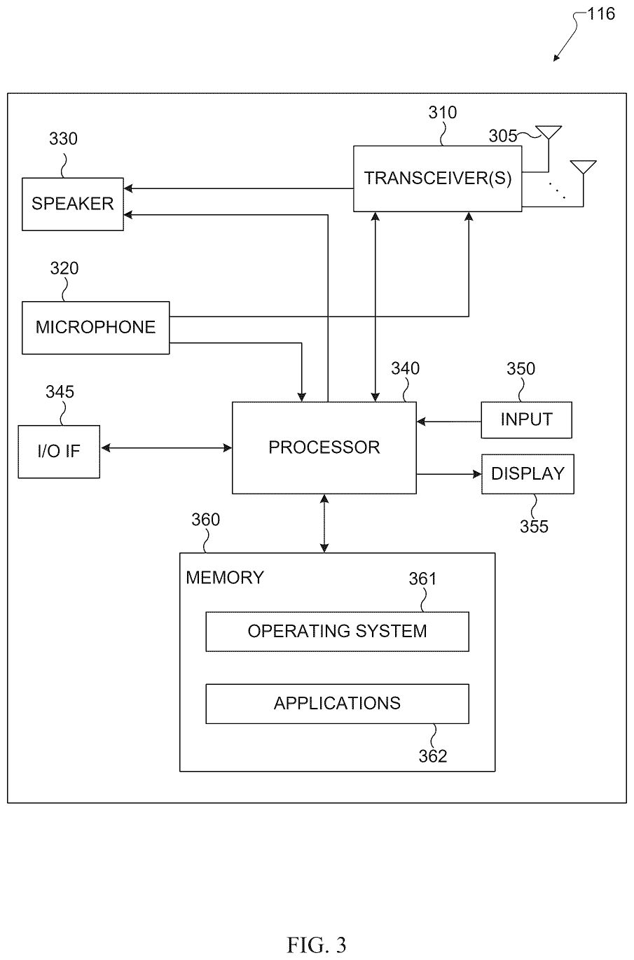

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize UE-initiated spatial relation activation and indication as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

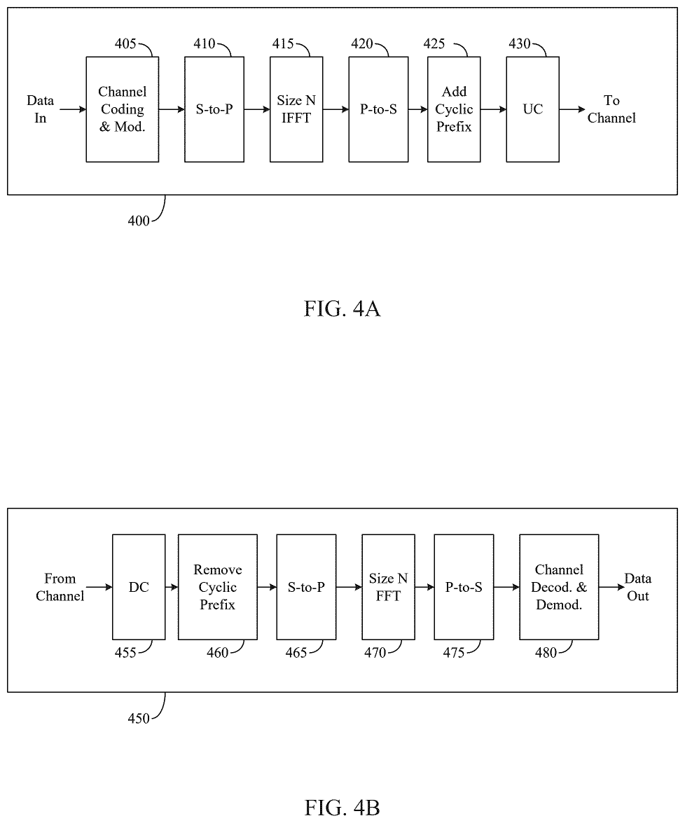

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support UE-initiated spatial relation activation and indication as described in embodiments of the present disclosure. In some embodiments, the receive path 450 is configured to support UE-initiated spatial relation activation and indication as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

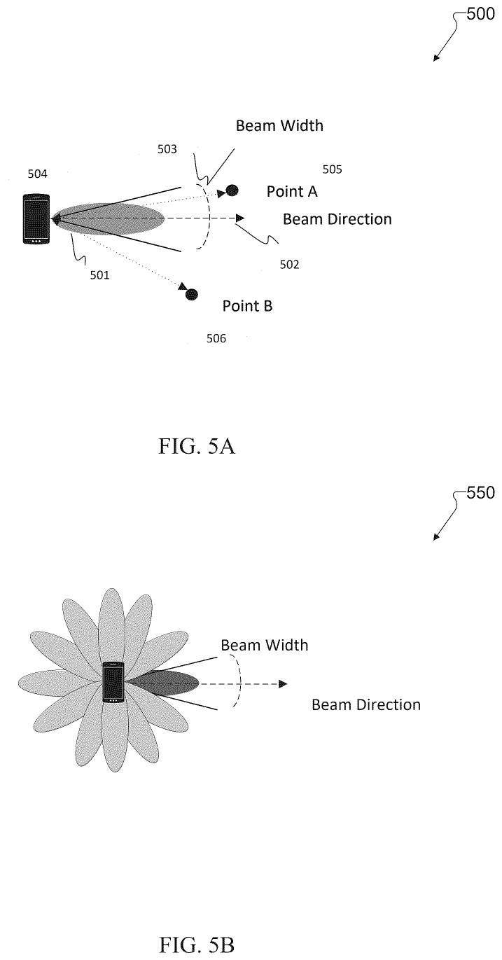

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

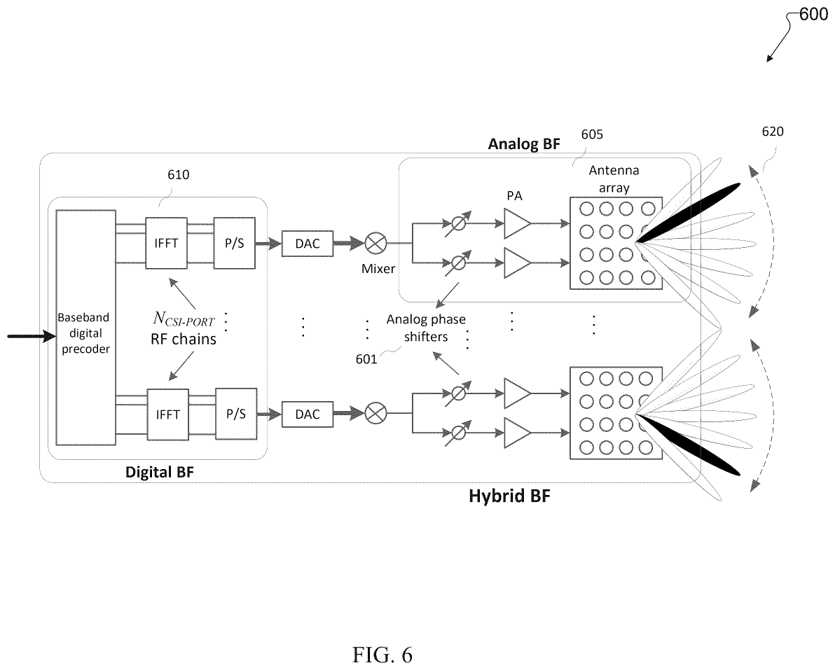

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). A slot can include sub-band full duplex (SBFD) symbols, wherein a symbol includes DL sub-band(s) and UL sub-band(s). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI)/configured scheduling RNTI (CS-RNTI)/modulation and coding scheme (MCS)-C-RNTI as described in [REF 2], are referred for brevity as a unicast DCI format. A DCI format scheduling PDSCH reception for multicast communication, such as a DCI format with CRC scrambled by group RNTI (G-RNTI)/G-CS-RNTI as described in [REF 2], are referred to as multicast DCI format. DCI formats providing various control information to at least a subset of UEs in a serving cell, such as DCI format 2_0 in [REF 2], are referred to as group-common (GC) DCI formats.

The downlink physical-layer processing of transport channels on PDSCH can include the following steps: (1) Transport block CRC attachment; (2) Code block segmentation and code block CRC attachment; (3) Channel coding: LDPC coding; (4) Physical-layer hybrid-ARQ processing; (5) Rate matching; (6) Scrambling; (7) Modulation: QPSK, 16QAM, 64QAM, 256QAM, and 1024QAM; (8) Layer mapping; and (9) Mapping to assigned resources and antenna ports.

As mentioned herein, the Physical Downlink Control Channel (PDCCH) can be used to schedule DL transmissions on PDSCH and UL transmissions on PUSCH, where the Downlink Control Information (DCI) on PDCCH includes: (1) Downlink assignments containing at least modulation and coding format, resource allocation, and hybrid-ARQ information related to DL-SCH; and (2) Uplink scheduling grants containing at least modulation and coding format, resource allocation, and hybrid-ARQ information related to UL-SCH. In addition to scheduling, PDCCH can be used to for: (1) Activation and deactivation of configured PUSCH transmission with configured grant; (2) Activation and deactivation of PDSCH semi-persistent transmission; (3) Notifying one or more UEs of the slot format; (4) Notifying one or more UEs of the RB(s) and OFDM symbol(s) where the UE may assume no transmission is intended for the UE; (5) Transmission of transmit power control (TPC) commands for physical uplink control channel (PUCCH) and PUSCH; (6) Transmission of one or more TPC commands for SRS transmissions by one or more UEs; (7) Switching a UE's active bandwidth part; (8) Initiating a random access procedure; (9) Indicating the UE(s) to monitor the PDCCH during the next occurrence of the discontinuous reception (DRX) on-duration; (10) In integrated access and backhaul (IAB) context, indicating the availability for soft symbols of an IAB-DU; (11) Triggering one shot hybrid automatic repeat request acknowledgement (HARQ-ACK) codebook feedback; and (12) For operation with shared spectrum channel access: (12a) Triggering search space set group switching; (12b) Indicating one or more UEs about the available RB sets and channel occupancy time duration; and (12c) Indicating downlink feedback information for configured grant PUSCH (CG-DFI). Polar coding is used for PDCCH. QPSK modulation is used for PDCCH.

A BS (such as BS 102) transmits one or more of multiple types of RS including channel state information RS (CSI-RS) and demodulation RS (DMRS). A CSI-RS is primarily intended for UEs to perform measurements and provide channel state information (CSI) to a BS. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116) can determine CSI-RS transmission parameters through DL control signaling or higher layer signaling, such as radio resource control (RRC) signaling from a BS. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a BS to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The BS can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, CSI reports enabling a BS to select appropriate parameters for PDSCH or PDCCH transmissions to a UE, and UE initiated report indicator (UEI-RI) indicating a request to transmit a UE initiated measurement report. HARQ-ACK information can be configured to be with a smaller granularity than per TB and can be per data code block (CB) or per group of data CBs where a data TB includes a number of data.

A CSI report from a UE can include a channel quality indicator (CQI) informing a BS of a largest modulation and coding scheme (MCS) for the UE to detect a data TB with a predetermined block error rate (BLER), such as a 10% BLER, of a precoding matrix indicator (PMI) informing a BS how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A BS can use a DMRS to demodulate information in a respective PUSCH or PUCCH. SRS is transmitted by a UE to provide a BS with an UL CSI and, for a TDD system, an SRS transmission can also provide a PMI for DL transmission. Additionally, in order to establish synchronization or an initial higher layer connection with a BS, a UE can transmit a physical random-access channel (PRACH).

An antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH demodulation reference signal (DM-RS) and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

In this Disclosure, [DEF1] a Beam can be Determined by any of:
A TCI state, that establishes a quasi-colocation (QCL) relationship or spatial relation between a source reference signal (e.g. SSB and/or CSI-RS and/or SRS) and a target reference signal
A spatial relation information that establishes an association to a source reference signal, such as SSB or CSI-RS or SRS.

### Alternatively, [DEF2] a Beam can be Determined by any of:

A port with a static/fixed (e.g. for FR1) or dynamic virtualization (e.g. FR2, FR3), or
A port group (PG) comprising multiple ports, with a dynamic indication/assignment of one (or two) ports from the multiple ports and associated QCL property=QCL TypeD or spatial relation.

In either case, the ID of the source reference signal or the one (or two) port(s) identifies the beam.

Alternatively, [DEF3] a Beam can be Determined by a Pair [a, B], which is any of
[A, B]=[TCI state, port]
[A, B]=[TCI state, PG]
[A, B]=[Spatial relation information, port]
[A, B]=[Spatial relation information, PG]

Where TCI state, spatial relation information, port and PG are as described herein. In this case, a pair of IDs for [A, B] identifies the beam.

According to [DEF1], the TCI state and/or the spatial relation reference RS can determine a spatial Rx filter or quasi-co-location (QCL) properties for reception of downlink channels at the UE, or a spatial Tx filter for transmission of uplink channels from the UE. The TCI state and/or the spatial relation reference RS can also determine a spatial Tx filter for transmission of downlink channels from the BS, or a spatial Rx filter or quasi-co-location (QCL) properties for reception of uplink channels at the BS.

Likewise, for [DEF2], the port with dynamic virtualization and/or the PG with dynamic indication of one (or two) ports can determine a spatial Rx filter or quasi-co-location (QCL) properties or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the BS, or a spatial Rx filter or quasi-co-location (QCL) properties or a port or a PG for reception of uplink channels at the BS. In one example, a port can be associated with or indicated by a TCI state.

Likewise, for [DEF3], A and B together can determine a spatial Rx filter or quasi-co-location (QCL) properties for reception of downlink channels at the UE, or a spatial Tx filter for transmission of uplink channels from the UE. They can also determine a spatial Tx filter for transmission of downlink channels from the BS, or a spatial Rx filter or quasi-co-location (QCL) properties for reception of uplink channels at the BS.

Rel-17 introduced the unified TCI framework, where a unified or main or indicated TCI state is signaled to the UE. The unified or main or indicated TCI state can be one of.
1. In case of joint TCI state indication, wherein a same beam or port/PG is used for DL and UL channels, a joint TCI state that can be used at least for UE-dedicated DL channels and UE-dedicated UL channels.
2. In case of separate TCI state indication, wherein different beams or ports/PGs are used for DL and UL channels, a DL TCI state that can be used at least for UE-dedicated DL channels.
3. In case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on PDSCH/PDCCH or dynamic-grant/configured-grant based PUSCH and dedicated PUCCH resources.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that can be directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [[REF 4]-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g. format 0_1 or 0_2), wherein the DCI format includes a “transmission configuration indication” field that includes/indicates a TCI state code point out of the TCI state code points activated by a MAC CE. A DL related DCI format (or an UL related DCI format) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state code point can be indicated by a purpose designed channel or DCI Format. A TCI state (TCI state code point) indicated/included in a DL related DCI format or UL related DCI format or purpose designed channel or DCI Format is applied after a beam application time from the corresponding HARQ-ACK feedback in a PUCCH or a PUSCH transmission.

In this disclosure, aspects related to UE initiated antenna port activation and indication and UE initiated beam activation and indication are provided. An antenna port or a beam can be indicated by a TCI state ID or reference signal ID, a TCI state ID or reference signal ID can be for example, an antenna port ID. In one example, an antenna port or TCI state or reference signal represents indication for a channel with one-input and one-output. A unit for spatial relation indication or beam indication can be referred to a spatial relation unit.

In NR, there are different levels of abstraction for beam indication and antenna port indication, which adds unnecessary complexity to MIMO and beam indication. To simplify beam and/or antenna port indication, a spatial resource unit is regarded as the basic unit, wherein the spatial resource unit, is a one-port channel, with one-input and one-output. “An antenna port is defined such that the channel over which a symbol on the antenna port is conveyed can be inferred from the channel over which another symbol on the same antenna port is conveyed” [REF 1]. A UE can be indicated with one or more spatial resource unit.

For application of a spatial resource unit, the spatial resource unit is first activated, and then indicated. The activation of a spatial resource unit, allows the UE time to measure the spatial resource unit and be ready to use it when it is indicated. The indication of the spatial resource unit is when the UE is signaled to use the spatial resource unit. A UE can be configured multiple spatial resource units. The multiple spatial resource units can be in a same set for example, one set for DL, UL or joint spatial resource units, or in different sets, for example one set for DL or joint spatial resource units and one set for UL spatial resource units. The UE can then be activated one or more of the spatial resource units. The spatial resource units can be activated in a single set or in multiple sets. The UE can then be indicated one or more spatial resource units from the activated spatial resource units.

In this disclosure a spatial resource unit is defined as a reference signal (e.g., a reference signal with one antenna port) or an antenna port of a reference signal. A spatial resource unit is identified by an ID (e.g., spatial resource unit ID). A spatial resource unit can be referred to as a TCI state, hence, a spatial resource unit ID can be referred to as a TCI state ID. A spatial resource unit can be referred to as an antenna port (or a port), hence, a spatial resource unit ID can be referred to as an antenna port ID or port ID. A spatial resource unit can be referred to as a reference signal, hence, a spatial resource unit ID can be referred to as a reference signal ID.

In some scenarios, the UE is aware of the channel condition and can make a better determination of the beam or beams to use, rather than relying on the method of having the network trigger beam measurement reporting, and the UE performs and reports the beam measurements for the network to decide which beam to apply. In Rel-19, UE initiated beam reporting is being introduced, where based on a condition (e.g., channel condition of a new beam is better by a threshold than the channel condition of the current beam), the UE can initiate beam reporting. Beam activation, assignment and indication can then be done by the network.

Embodiments of the present disclosure recognize that, to further reduce latency in beam management procedure, some of the beam management procedures can be done by the UE and signaled to the network. In one example, the UE can signal to network the spatial resource units to activate, or to activate spatial resource units and signal the activated spatial resource units to the network. In one example, the activated spatial resource units can be from the configured spatial resource units.

In one example, the UE (e.g., the UE 116) can signal to network (e.g., the network 130) the spatial resource units to apply, or to apply spatial resource units and signal the applied spatial resource units to the network. In one example, the applied spatial resource units can be from the activated spatial resource units. In one example, the applied spatial resource units can be from the configured spatial resource units. In some example of this disclosure, the applied spatial resource units can be referred to as indicated spatial resource units.

In one example, the activation time of a TCI state or spatial resource unit depends on whether a TCI state or spatial resource unit or reference signal associated with the TCI state or spatial resource unit is known or not (e.g., has a known synchronization status or not as described later in this disclosure). The reference signal associated with the TCI state or spatial resource unit can be source reference signal with QCL-TypeD in the TCI state or spatial resource unit, or can be a spatial relation source reference signal. In one example, a reference signal or TCI state or spatial relation resource unit is known if the reference signal or reference signal associated with the TCI state or spatial resource unit has been recently measured or received. In one example, the network activates one or more TCI states or spatial resource units, and the UE in response to the activation message indicates the time the TCI state(s) or spatial resource unit(s) will become active. In one example, the network activates one or more TCI states or spatial resource units, the network/BS and UE know and are aligned about the status of the reference signal(s) associated with the TCI states or spatial resource units (i.e., whether the reference signals or TCI states or spatial resources are known or unknown), the time of activation of TCI state(s) or spatial resource unit(s) is based on that.

In this disclosure, signaling methods are provided for UE initiated activation and indication of spatial resource units. The signaling of these methods are provided.

The present disclosure relates to a NR/5G and/or 6G communication system.

This disclosure provides aspects related to UE initiated spatial resource unit configuration activation and indication:
Signaling from the UE of spatial resource units to activate or spatial resource units to deactivate.
Signaling from the UE of spatial resource units to indicate (i.e., apply to the spatial domain filter).
Timing aspects related to UE initiated spatial resource units' activation and indication and spatial resource units activated by network based on synchronization status of spatial resource units or associated reference signal.

In the following, both frequency division duplexing (FDD) and time division duplexing (TDD) are regarded as a duplex method for DL and UL signaling. In addition, full duplex (XDD) operation is expected, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or to all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or all UEs in cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format in DL or uplink control information (UCI) in UL) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or BS) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or BS) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-reference signal received power (RSRP)/L1-signal-to-interference-plus-noise ratio (SINR) accompanied by at least one CSI-RS resource indicator (CRI) or SSB resource indicator (SSBRI)). As the NW/BS (e.g., the network 130/the BS 102) receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/BS receives the source RS, the NW/BS can measure and calculate the needed information to assign a particular DL (or/and UL) TX beam to the UE, for example in case of channel reciprocity.

In one example of this disclosure, a reference signal can be configured with one antenna port.

In one example of this disclosure, a reference signal can be configured with N antenna ports.

In one example, an entity for spatial domain (or spatial relation) indication (e.g., a spatial domain resource unit) is a TCI state. Wherein, a TCI state can include:
A TCI state ID
One or more QCL information elements. Wherein, a QCL information element can include
   Reference signal ID (e.g., reference signal configured with one antenna port)
   One or more QCL Types. (e.g., QCL Type-A or Type-B or Type-C, and/or QCL Type-D)

In some of the examples of this disclosure a set A has N elements and a subset of set A, i.e., set B is signaled. Set B has M elements. In one example, each element of A has an index from 0 to N−1. In one example, the index can be an ID associated with the element. In one example, the index can be the position of the element in set A, for example, the first element has index 0, the second element has index 1, and so on. The Nth element has index N−1.

In one example, to signal set B a field map of size M×[log₂ N] is used, where a field corresponds to each element of set B, each field has size [log₂ N] indicating a corresponding element in set A. In one example, the order of the M elements in set B can be the order of the element in the field map. In one example, the order of the M elements in set B can be arranged in ascending order of index from set A. In one example, the order of the M elements in set B can be arranged in descending order of index from set A.

In one example, to signal set B a field of size [M×log₂ N] is used, where a field corresponds to each element of set B. In one example, each field has size [log₂ N] indicating a corresponding element in set A. In one example, the field has a value,

$$F = {\sum }_{m = 0}^{M - 1} {b}_{m} \times {N}^{m} ,$$

where bₘ is the value of element m in set B. The value of element m corresponds to the index of that element in set A, in the range 0, 1, . . . , N−1. In one example, the element with index m, where m=0,1, . . . , M−1 has a value of

$$⌊ \frac{F}{{N}^{m}} ⌋ \% N ,$$

where % is the modulo operator (a=b % c, where a is the remainder of dividing b by c). In one example, the order of the M elements in set B can be based on index m. In one example, the order of the M elements in set B can be arranged in ascending order of index (value) from set A. In one example, the order of the M elements in set B can be arranged in descending order of index (value) from set A.

In one example, a combinatorial index is used for signaling the M elements of set B from the N elements of set A. In one example, the size of the field map can be

$$⌈ {log}_{2} ( \begin{matrix}N \\ M\end{matrix} ) ⌉ .$$

A unique combinatorial index can be found for set B {b₀, b₁, . . . , b_{M-1}}, where bₘ for m=0, 1, . . . , M−1, corresponds to an element of set A (e.g., an index of an element in set A in the range 0, 1, . . . , N−1). In one example, b₀, b₁, . . . , b_{M-1} are arranged in a set S3 such that b₀>b₁> . . . >b_{K-1}, the index indicating set B is given by:

$${\sum }_{m = 1}^{M - 1} 〈 \begin{matrix}{b}_{m} \\ M - m\end{matrix} 〉 , where$$

$$〈 \begin{matrix}x \\ y\end{matrix} 〉 = \{ \begin{matrix}( \begin{matrix}x \\ y\end{matrix} ) & x \geq y \\ 0 & otherwise\end{matrix}$$

$$( \begin{matrix}x \\ y\end{matrix} ) = \frac{x !}{( x - y ) ! y !}$$

In one example, b₀, b₁, . . . , b_{M-1} are arranged in the set S3 such that b₀<b₁< . . . <b_{K-1} the index indicating set B is given as mentioned herein.

In one example, the order of the M elements in set B can be arranged in ascending order of index from set A. In one example, the order of the M elements in set B can be arranged in descending order of index from set A.

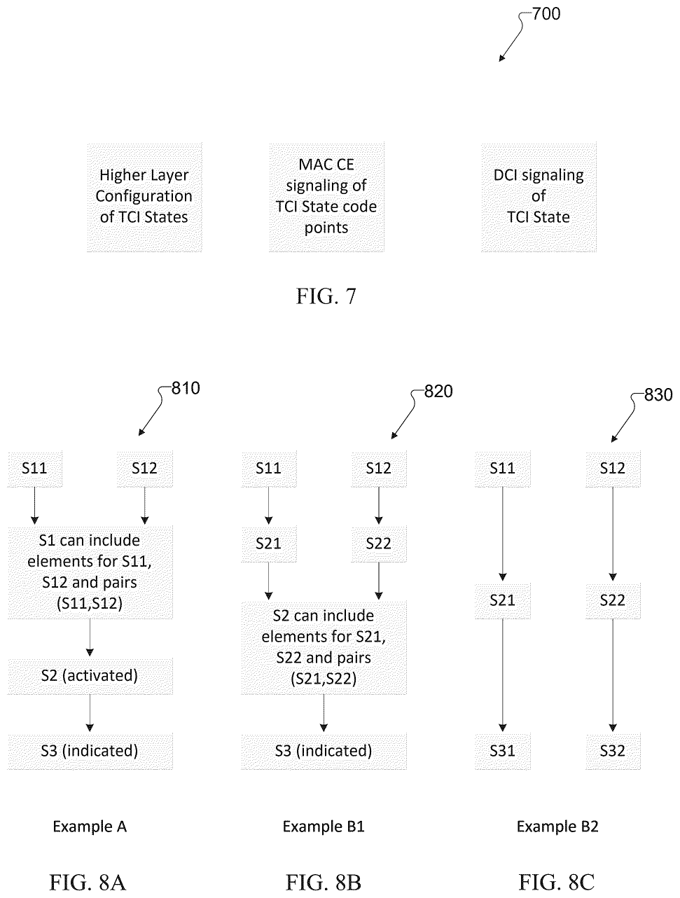

FIG. 7 illustrates examples of higher layer signaling 700 according to embodiments of the present disclosure. For example, higher layer signaling 700 can be received by any of the UEs 111-116 of FIG. 1. This example is for illustration only and other embodiments can be used without departing from the scope of the present disclosure.

In the following examples, as illustrated in FIG. 7, a UE is configured/updated through higher layer RRC signaling a set S1 of spatial resource units with L elements or a set S1 of TCI States with L elements or a set S1 of reference signals, e.g., for beam indication with L elements. A set S2 of K elements (K≤L) can be activated by the network from set S1. Where, elements of set S2 can be activated spatial resource units or spatial resource unit code points or activated TCI states or TCI state code points or reference signals or reference signal code points from the set of L spatial resource units or the set of L TCI states or the set of L reference signal. In one example, set S2 is referred to as a multi-variate TCI state (e.g., activated multi-variate TCI state (mv-TCI state)) or multi-variate spatial resource unit (mv-SRU). A UE can be indicated by the network M elements (denoted as S3) from set S2. In one example, S3 is referred to as a multi-variate TCI state (e.g., indicated multi-variate TCI state (mv-TCI state)) or multi-variate spatial resource unit (my-SRU).

In one example, the activation of set S2 is by higher layer signaling, e.g., MAC CE signaling or RRC signaling. In one example, the activation of set S2 is by L1 control (e.g., DCI Format) signaling. In one example, the indication of set S3 is by higher layer signaling, e.g., MAC CE signaling or RRC signaling. In one example, the indication of set S3 is by L1 control (e.g., DCI Format) signaling. In one example, the activation of set S2 and the indication of set S3 are in a same signal. In one example, the activation of set S2 and the indication of set S3 is by higher layer signaling, e.g., MAC CE signaling or RRC signaling. In one example, the activation of set S2 and the indication of set S3 is by L1 control (e.g., DCI Format) signaling.

FIGS. 8A, 8B, and 8C illustrate examples of spatial resource unit set configurations 810, 820, and 830, respectively, according to embodiments of the present disclosure. For example, any of the UEs 111-116 of FIG. 1, such as the UE 111, can be configured by spatial resource unit set configurations 810, 820, and 830, respectively. This example is for illustration only and other embodiments can be used without departing from the scope of the present disclosure.

In the following examples, a UE is configured/updated through higher layer RRC signaling a first set S11 of spatial resource units with L1 elements or a set S11 of TCI States with L1 elements or a set S11 of reference signals, e.g., for beam indication with L1 elements, and a second set S12 of spatial resource units with L2 elements or a set S12 of TCI States with L2 elements or a set S12 of reference signals, e.g., for beam indication with L2 elements. In one example, the first set can correspond to DL or joint beam indication and the second set can correspond to UL beam indication. In one example, the first set can correspond to a first entity (e.g., first TRP or a first cell or a first panel) and the second set can correspond to a second entity (e.g., second TRP or a second cell or a second panel).

In one example, A, as illustrated in FIG. 8(A), a set S2 of K elements is activated from set S11 and set S12. Where, elements of set S2 can be activated spatial resource units or spatial resource unit code points or TCI states or TCI state code points or reference signals or reference signal code points from the sets of L1 and L2 spatial resource units or the sets of L1 and L2 TCI states or the sets of L1 and L2 reference signal. In one example a code point in set S2 can include zero or one or more of: (1) element from set S11, (2) element from set S12, and (3) a pair including element from set S11 and element from set S12. In one example, set S2 is referred to as a multi-variate TCI state (e.g., activated multi-variate TCI state (mv-TCI state)) or multi-variate spatial resource unit (mv-SRU). A UE is indicated M elements (denoted as set S3) from set S2. In one example, set S3 is referred to as a multi-variate TCI state (e.g., indicated multi-variate TCI state (mv-TCI state)) or multi-variate spatial resource unit (mv-SRU).

In one example, a set S1 is created from the sets S11 and S12 according to the following examples.

In one example, set S1 contains the order pairs of pairs of elements from set S11 and from set 512. The size of S1 can be L1·L2 elements. In one example, a pair of elements with index l1a, can correspond to an element with index l1 from set S11 and an element with index l2 from set S12, such that

$$l 1 a = l 1 \cdot L 2 + l 2 , l 1 = ⌊ \frac{l 1 a}{L 2} ⌋ ,$$

and/or l2=l1a % L2, where % is the modulo operator (a=b % c, where a is the remainder of dividing b by c). In one example, a pair of elements with index l1a, can correspond to an element with index l1 from set S11 and an element with index l2 from set S12, such that

$$l 1 a = l 2 \cdot L 1 + l 1 , l 2 = ⌊ \frac{l 1 a}{L 1} ⌋ ,$$

and/or l1=l1a % L1.

In one example, S1 includes first (L1·L2) pair of elements from S11 and S12, second the L1 elements from S11, third the L2 elements from S12. In one example, an element in S1 with index l1b, where l1b<L1·L2, can correspond to a pair of elements, an element with index l1 from set S11 and an element with index l2 from set S12, such that

$$l 1 b = l 1 \cdot L 2 + l 2 , l 1 = ⌊ \frac{l 1 b}{L 2} ⌋ ,$$

and/or l2=l1b % L2, where % is the modulo operator (a=b % c, where a is the remainder of dividing b by c). In one example, an element in S1 with index l1b, where l1b<L1 L2, can correspond to a pair of elements, an element with index l1 from set S11 and an element with index l2 from set S12, such that

$$l 1 b = l 2 \cdot L 1 + l 1 , l 2 = ⌊ \frac{l 1 b}{L 1} ⌋ ,$$

and/or l1=l1b % L1. An element in S1 with index l1b, where L1 L2 l1b<L1 L2+L1, can correspond to an element with index l1 from set S11, such that l1b=l1+L1·L2. An element in S1 with index l1b, where L1·L2+L1 l1b<L1 L2+L1+L2, can correspond to an element with index l2 from set S12, such that l1b=l2+L1 L2+L1.

In one example, S1 includes first L1 elements from S11, second L2 elements from S12, third (L1·L2) pair of elements from S11 and S12. An element in S1 with index l1b, where l1b<L1, can correspond to an element with index l1 from set S11, such that l1b=l1. An element in S1 with index l1b, where L1 l1b<L1+L2, can correspond to an element with index l2 from set S12, such that l1b=l2+L1. In one example, an element in S1 with index l1b, where L1+L2 l1b<L1+L2+L1 L2, can correspond to a pair of elements, an element with index l1 from set S11 and an element with index l2 from set S12, such that

$$l 1 b = L 1 + L 2 + l 1 \cdot L 2 + l 2 ,$$

$$l 1 = ⌊ \frac{l 1 b - L 1 - L 2}{L 1} ⌋ ,$$

and/or l2=(l1b−L1·L2) % L2, where % is the modulo operator (a=b % c, where a is the remainder of dividing b by c). In one example, an element in S1 with index l1b, where L1+L2 l1b<L1+L2+L1 L2, can correspond to a pair of elements, an element with index l1 from set S11 and an element with index l2 from set S12, such that

$$l 1 b = L 1 + L 2 + l 2 \cdot L 1 + l 1 , l 2 = ⌊ \frac{l 1 b - L 1 - L 2}{L 1} ⌋ ,$$

and/or l1=(l1b−L1·L2) % L1.

### The Order of the Elements in S1 can be:

First pairs of elements from S11 and S12, second elements from S11, third elements from S12, as described herein.
First pairs of elements from S11 and S12, second elements from S12, third elements from S11.
First elements from S11, second elements from S12, third pairs of elements from S11 and S12, as described herein.
First elements from S12, second elements from S11, third pairs of elements from S1 and S12.
First elements from S11, second pairs of elements from S11 and S12, third elements from S12.
First elements from S12, second pairs of elements from S11 and S12, third elements from S11.

In one example, S1 contains the order pairs of pairs of elements from set S11+ and from set S12+. Where, set S11+ can include the elements of S11, and an additional element indicating no element of set S11 activated, for example the additional element can be added at the start of set S11 or at the end of set S11, denote this element as E1. Where, set S12+ can include the elements of S12, and an additional element indicating no element of set S12 activated, for example the additional element can be added at the start of set S12 or at the end of set S12, denote this element as E2. The ordered pair created from set S11+ and set S12+ can be one of the following:
Element from set S11 and element from set S12. This corresponds to a pair of elements from S11 and S12.
Element from set S11 and E2. This corresponds to an element from S11.
E1 and element from set S12. This corresponds to an element from S12.
E1 and E2. This corresponds to no activated elements. In one example, this element is removed from set S1. In one example, this element is maintained in set S1 and can be used, for example, to signal an element in S2 not activated.

In one example, the size of S1 can be (L1+1)·(L2+1) elements, for example element corresponding to E1 and E2 is retained. In one example, the size of S1 can be (L1+1)·(L2+1)−1 elements, for example element corresponding to E1 and E2 is removed.

In one example, as illustrated in FIG. 8(B) and FIG. 8(C), a set S21 of K1 is activated from set S11, and a set S22 of K2 elements is activated from set S12. Where, elements of set S21 can be activated spatial resource units or spatial resource unit code points or TCI states or TCI state code points or reference signals or reference signal code points from the set of L1 spatial resource units or the set of L1 TCI states or the set of L1 reference signal. In one example, set S21 is referred to as a multi-variate TCI state (e.g., first activated multi-variate TCI state (mv-TCI state)) or multi-variate spatial resource unit (mv-SRU). Where, elements of set S22 can be activated spatial resource units or spatial resource unit code points or TCI states or TCI state code points or reference signals or reference signal code points from the set of L2 spatial resource units or the set of L2 TCI states or the set of L2 reference signals. In one example, set S22 is referred to as a multi-variate TCI state (e.g., second activated multi-variate TCI state (mv-TCI state)) or multi-variate spatial resource unit (mv-SRU). In one example, set S21 and S22 are referred to as a multi-variate TCI state (e.g., activated multi-variate TCI state (mv-TCI state)) or multi-variate spatial resource unit (mv-SRU).

In one example, B1, as illustrated in FIG. 8(B), a UE (e.g., the UE 116) is indicated M elements (denoted as set S3) from set S21 and/or set S22. An element of the M elements of S3 can be: (1) element from set S21, (2) element from set S22 or (3) a pair including element from set S21 and element from set S22. In one example, set S3 is referred to as a multi-variate TCI state (e.g., indicated multi-variate TCI state (mv-TCI state)) or multi-variate spatial resource unit (my-SRU).

In one example, a set S2 is created from the sets S21 and S22 according to the following examples:

In one example, set S2 contains the order pairs of pairs of elements from set S21 and from set S22. The size of S2 can be K1·K2 elements. In one example, a pair of elements with index k1a, can correspond to an element with index k1 from set S21 and an element with index k2 from set S22, such that

$$k 1 a = k 1 \cdot K 2 + k 2 , k 1 = ⌊ \frac{k 1 a}{K 2} ⌋ ,$$

and/or k2=k1a % K2, where % is the modulo operator (a=b % c, where a is the remainder of dividing b by c). In one example, a pair of elements with index k1a, can correspond to an element with index k1 from set S21 and an element with index k2 from set S22, such that

$$k 1 a = k 2 \cdot K 1 + k 1 , k 2 = ⌊ \frac{k 1 a}{K 1} ⌋ ,$$

and/or k1=k1a % K1.

In one example, S2 includes first (K1 K2) pairs of elements from S21 and S22, second the K1 elements from S21, third the K2 elements from S22. In one example, an element in S2 with index k1b, where k1b<K1−K2, can correspond to a pair of elements, an element with index k1 from set S21 and an element with index k2 from set S22, such that

$$k 1 b = k 1 \cdot K 2 + k 2 , k 1 = ⌊ \frac{k 1 b}{K 2} ⌋ ,$$

and/or k2=k1b % K2, where % is the modulo operator (a=b % c, where a is the of dividing b by c). In one example, an element in S2 with index k1b, where k1b<K1·K2, can correspond to a pair of elements, an element with index k1 from set S21 and an element with index k2 from set S22, such that

$$k 1 b = k 2 \cdot K 1 + k 1 , k 2 = ⌊ \frac{k 1 b}{K 1} ⌋ ,$$

and/or k1=k1b % K1. An element in S2 with index k1b, where K1·K2 k1b≤K1·K2+K1, can correspond to an element with index k1 from set S21, such that k1b=k1+K1·K2. An element in S2 with index k1b, where K1·K2+K1≤k1b<K1·K2+K1+K2, can correspond to an element with index k2 from set S22, such that k1b=k2+K1·K2+K1.

In one example, S2 includes first the K1 elements from S21, second the K2 elements from S22, third the (K1·K2) pairs of elements from S21 and S22. An element in S2 with index k1b, where k1b<K1, can correspond to an element with index k1 from set S21, such that k1b=k1. An element in S2 with index k1b, where K1<k1b<K1+K2, can correspond to an element with index k2 from set S22, such that k1b=k2+K1. In one example, an element in S2 with index k1b, where K1+K2<k1b<K1+K2+K1·K2, can correspond to a pair of elements, an element with index k1 from set S21 and an element with index k2 from set S22, such that

$$k 1 b = K 1 + K 2 + k 1 \cdot K 2 + k 2 , k 1 = ⌊ \frac{k 1 b - K 1 - K 2}{K 2} ⌋ ,$$

and/or k2=(k1b−K1−K2) % K2, where % is the modulo operator (a=b % c, where a is the remainder of dividing b by c). In one example, an element in S2 with index k1b, where K1+K2≤k1b<K1+K2+K1−K2, can correspond to a pair of elements, an element with index k1 from set S21 and an element with index k2 from set S22, such that

$$k 1 b = K 1 + K 2 + k 2 \cdot K 1 + k 1 , k 2 = ⌊ \frac{k 1 b - K 1 - K 2}{K 1} ⌋ ,$$

and/or k1=(k1b−K1−K2) % K1.

### The Order of the Elements in S1 can be:

First pairs of elements from S21 and S22, second elements from S21, third elements from S22, as described herein.
First pairs of elements from S21 and S22, second elements from S22, third elements from S21.
First elements from S21, second elements from S22, third pairs of elements from S21 and S22, as described herein.
First elements from S22, second elements from S21, third pairs of elements from S21 and S22.
First elements from S21, second pairs of elements from S21 and S22, third elements from S22.
First elements from S22, second pairs of elements from S21 and S22, third elements from S21.

In one example, S2 contains the order pairs of pairs of elements from set S21+ and from set S22+. Where, set S21+ can include the elements of S21, and an additional element indicating no element of set S21 indicated, for example the additional element can be added at the start of set S21 or at the end of set S21, denote this element as E1. Where, set S22+ can include the elements of S22, and an additional element indicating no element of set S22 indicated, for example the additional element can be added at the start of set S22 or at the end of set S22, denote this element as E2. The ordered pair created from set S21+ and set S22+ can be one of the following:
Element from set S21 and element from set S22. This corresponds to a pair of elements from S21 and S22.
Element from set S21 and E2. This corresponds to an element from S21.
E1 and element from set S22. This corresponds to an element from S22.
E1 and E2. This corresponds to no activated elements. In one example, this element is removed from set S2. In one example, this element is maintained in set S2 and can be used, for example, to signal an element in S2 not activated.

In one example, the size of S2 can be (K1+1)·(K2+1) elements, for example element corresponding to E1 and E2 is retained. In one example, the size of S2 can be (K1+1) (K2+1)−1 elements, for example element corresponding to E1 and E2 is removed.

In one example, B2, as illustrated in FIG. 8(C), a UE is indicated M1 elements (denoted as set S31) from set S21, M2 elements (denoted as set S32). In one example, set S31 is referred to as a multi-variate TCI state (e.g., first indicated multi-variate TCI state (mv-TCI state)) or multi-variate spatial resource unit (mv-SRU), and set S32 is referred to as a multi-variate TCI state (e.g., second indicated multi-variate TCI state (mv-TCI state)) or multi-variate spatial resource unit (my-SRU). In one example, sets S31 and S32 are referred to as a multi-variate TCI state (e.g., indicated multi-variate TCI state (mv-TCI state)) or multi-variate spatial resource unit (mv-SRU).
In one example of the following, when a single set S2 is activated, S2 and S2u and S2d (described later) are signaled from the elements of set S1, where set S1 can be configured as single set or created from two configured sets (S 11 and S12) as described herein.
In one example of the following, when two sets (S21 and S22) are activated, S2 and S2u and S2d (described later) signaled from the elements of S1 can correspond to one of:
   S21 and S21u and S21d signaled from the elements of S11.
   S22 and S22u and S22d signaled from the elements of S12.

### Where;

S21u is the set of spatial resource units to be activated (by UE) or recommended for activation by UE to the network (e.g., the network 130) corresponding to the first set of configured spatial resource units S11, and
S21d is the set of activated spatial resource units to be deactivated (by UE) or recommended for deactivation by UE to the network corresponding to the first set of configured spatial resource units S11, and
S22u is the set of spatial resource units to be activated (by UE) or recommended for activation by UE to the network corresponding to the second set of configured spatial resource units S12, and
S22d is the set of activated spatial resource units to be deactivated (by UE) or recommended for deactivation by UE to the network corresponding to the second set of configured spatial resource units S12.

In one example, the UE signals to the network a set S2u of spatial resource units with Ku elements for activation. The network can update elements of set S2 based on set S2u (or some of the elements of set S2u) from the UE.

In one example, set S2u is signaled as a field-map of Ku elements, wherein each field element signals an index from set S1. In one example, the size of the field map can be Ku×[log₂ L], where [log₂ L] is the size of each field element and Ku is the number of field elements. In one example, the order of the Ku elements in set S2u can be arranged in ascending order of index from set S1. In one example, the order of the Ku elements in set S2u can be arranged in descending order of index from set S1. In one example, the order of the Ku elements in set S2u can be arranged according to the order of corresponding elements in field map. In one example, the size of the field can be [Ku×log₂ L].

In one example, set S2u is signaled as a combinatorial index indicating Ku elements from set S1 with L elements. In one example, the size of the field map can be log₂ [(LKu)]. In one example, the order of the Ku elements in set S2u can be arranged in ascending order of index from set S1. In one example, the order of the Ku elements in set S2u can be arranged in descending order of index from set S1.

In one example, the message conveying S2u can be a two-stage message, for example, the first stage indicating the length or number of elements (e.g., Ku) signaled by the second stage and possibly one or more spatial resource units. In one example, the message conveying S2u is a single stage message and value of Ku is fixed (e.g., determined based on prior configuration or signaling). In one example, the message conveying S2u is a single stage message, and the value of Ku can vary (e.g., as indicated in the message).

In one example, the message conveying S2u is higher layer signaling, e.g., MAC CE signaling or RRC signaling. In one example, the message conveying S2u is L1 control signaling.

In one example, the UE activates (or pre-activates) the Ku spatial resource units of S2u. In one example, the Ku spatial resource units signaled in a message to BS become activated a time T (or no later than a time T) from the message containing S2u. In one example, T is measured from the start of the message. In one example, T is measured from the end of the message. In one example, the Ku spatial resource units signaled in a message to BS become activated a time T (or no later than a time T) from the ACK to the message containing S2u. In one example, T is measured from the start of the message carrying the ACK. In one example, T is measured from the end of the message carrying the ACK. In one example, T can be configured or updated by SIB and/or RRC and/or MAC CE and/or L1 control (e.g., DCI Format) signaling. In the example, the ACK is carried by a DCI Format and/or in a PDCCH channel. In one example, T=0. In one example, the TCI state is activated when the UE signals the TCI state for activation.

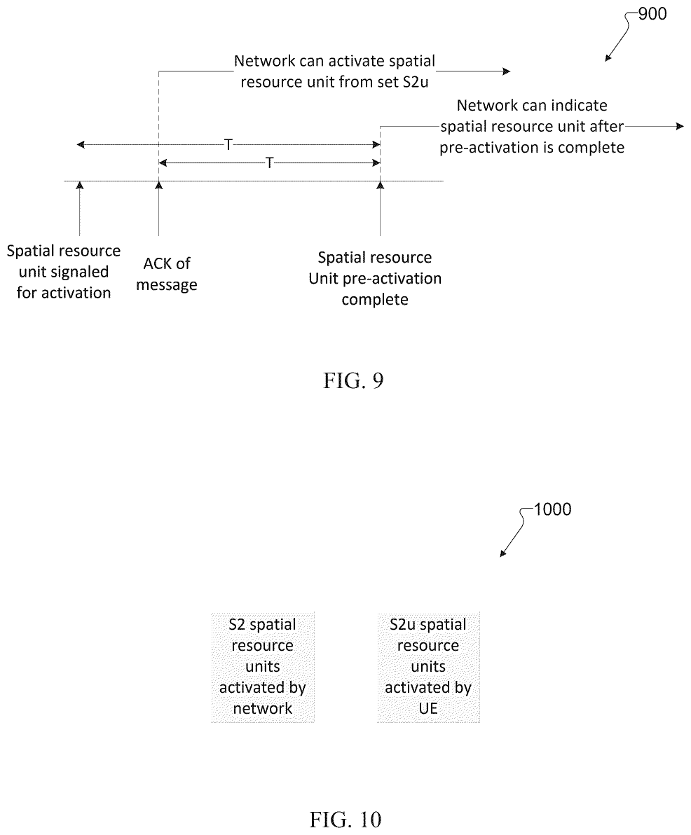

FIG. 9 illustrates a timeline 900 for indicating/activating a spatial resource unit according to embodiments of the present disclosure. For example, timeline 900 can be followed by the UE 112 and the network 130 and/or BS 102 in the wireless network 100 of FIG. 1. This example is for illustration only and other embodiments can be used without departing from the scope of the present disclosure.

In one example, as illustrated in FIG. 9, the UE signals a spatial resource unit (e.g., SRU1) for activation to the network, e.g., in set S2u. In one example, the UE can complete the activation of the spatial resource unit at or after (or no later than) time T from the message containing set S2u. In one example, the UE can complete the activation of the spatial resource unit at or after (or no later than) time T from the ACK of the message containing set S2u. In one example, the network can send a message signaling the activation of SRU1 after the ACK of the message as illustrated in FIG. 9. In one example, the network can send a message signaling the activation of SRU1 after the message containing S2u. In one example, the network can send a message signaling the activation of SRU1 after the spatial resource unit pre-activation is complete. In one example, the network can send a message signaling the activation and indication of SRU1 after the spatial resource unit pre-activation is complete. In one example, the network can send a message signaling the indication of SRU1 after the spatial resource unit pre-activation is complete as illustrated in FIG. 9. In the example, the ACK is carried by a DCI Format and/or in a PDCCH channel. In one example, T=0. In one example, the TCI state is activated when the UE signals the TCI state for activation.

In one example, if the network activates a spatial resource unit that the UE has signaled for activation, the network can indicate the spatial resource unit after spatial resource unit pre-activation is complete, e.g., as illustrated in FIG. 9.

In one example, if the network activates a spatial resource unit that the UE has not signaled for activation, the network can indicate the spatial resource unit after a time T1 from the message activating the spatial resource unit, or after a time T1 from the ACK of the message activating the spatial resource unit. In one example, if the network activates a spatial resource unit that the UE has signaled for activation, the network can indicate the spatial resource unit after a time T2 from the message activating the spatial resource unit, or after a time T2 from the ACK of the message activating the spatial resource unit. In one example, T1 and T2 can be different parameters. In one example, the network can configure and/or update T1 or T2 by SIB and/or RRC and/or MAC CE and/or L1 control (e.g., DCI Format) signaling. In one example, T1>T2. In one example, T1≥T2. In the example, the ACK is carried by a UCI Format and/or in a PUCCH or PUSCH channel. In one example, T2=0. In one example, the TCI state is activated when the UE signals the TCI state for activation.

In one example, the UE can signal its capability if it pre-activates spatial resource unit. In one example, a UE can signal whether or not a spatial resource unit is pre-activated. In one example, for pre-activated spatial resource units, time T2 can be used. In one example, for spatial resource units not pre-activated, time T1 applied.

In one example, the UE can signal Ku spatial resource units from set S2 for deactivation as set S2d. The network can deactivate elements of set S2 based on set S2d (or some of the elements of set S2d) from the UE. In one example, the elements of set S2 can be arranged in descending or ascending order of spatial resource unit index. In one example, the spatial resource unit index is determined by index (or order) of spatial resource unit in set S1. In one example, the spatial resource unit index can be determined by the order of a field map deactivating S2.

In one example, set S2d is signaled as a field-map of Ku elements, wherein each field element signals an index from set S2 to be deactivated. In one example, the size of the field map can be Ku×[log₂ K], where [log₂ K] is the size of each field element and Ku is the number of field elements. Wherein, K is the size of set S2. In a variant example, the signaled field elements for deactivation can be from set S1 (e.g., corresponding to elements that are activated in set S2), the size of the field map can be Ku×[log₂ L]. In one example, the size of the field can be [Ku×log₂ K]. In one example, the size of the field can be [Ku×log₂ L]. In one example, set S2d is signaled as a bitmap of K bits, wherein each bit signals whether or not to deactivate a corresponding element of S2. In one example, a bit with value 0 signals that the corresponding element is deactivated and a bit with value 1 signals that the corresponding element is not deactivated. In one example, a bit with value 0 signals that the corresponding element is not deactivated and a bit with value 1 signals that the corresponding element is deactivated.

In one example, set S2d is signaled as a combinatorial index indicating Ku elements from set S2 with K elements to be deactivated. In one example, the size of the field map can be

$$⌈ {log}_{2} ( \begin{matrix}K \\ Ku\end{matrix} ) ⌉ .$$

In variant example, the signaled field elements for deactivation can be from set S1 (e.g., corresponding to elements that are activated in set S2), the size of the field map can be

$$⌈ {log}_{2} ( \begin{matrix}L \\ Ku\end{matrix} ) ⌉ .$$

In one example, the message conveying S2d can be a two-stage message, for example, the first stage indicating the length or number of elements (e.g., Ku) signaled by the second stage and possibly one or more spatial resource units. In one example, the message conveying S2d is a single stage message and value of Ku is fixed (e.g., determined based on prior configuration or signaling). In one example, the message conveying S2d is a single stage message, and the value of Ku can vary (e.g., as indicated in the message).

In one example, the message conveying S2d is higher layer signaling, e.g., MAC CE signaling or RRC signaling. In one example, the message conveying S2d is L1 control signaling.

In one example, the UE can signal Ku spatial resource units from set S2 for deactivation as set S2d, and Ku spatial resource units from set S1 for activation. The network can deactivate and activate elements of set S2 based on sets S2d and S2u (or some of the elements of sets S2d and S2u) from the UE. The signaling for activation and deactivation can be as described herein.

In one example, the message conveying S2u and S2d can be a two-stage message, for example, the first stage indicating the length or number of elements (e.g., Ku) signaled by the second stage and possibly one or more spatial resource units for activation and/or deactivation. In one example, the message conveying S2u and S2d is a single stage message and value of Ku is fixed (e.g., determined based on prior configuration or signaling). In one example, the message conveying S2u and S2d is a single stage message, and the value of Ku can vary (e.g., as indicated in the message).

In one example, the message conveying S2u and S2d is higher layer signaling, e.g., MAC CE signaling or RRC signaling. In one example, the message conveying S2u and S2d is L1 control signaling.

FIG. 10 illustrates examples of spatial resource units 1000 according to embodiments of the present disclosure. For example, spatial resource units 1000 can be activated by any of the UEs 111-116 of FIG. 1, such as the UE 113. This example is for illustration only and other embodiments can be used without departing from the scope of the present disclosure.

In one example, the UE (e.g., the UE 116) activates and signals to the network a set S2u of spatial resource units with Ku elements. The set S2u of activated spatial resource units by the UE, can be in addition to set S2 of activated spatial resource units by the network as illustrated in FIG. 10. In one example, the BS (e.g., the BS 102) can update set S2 based on set S2u or some of the elements of set S2u. In one example, the indicated spatial resource units are from set S2. In one example, the indicated spatial resource units are from set S2 and/or S2u. In one example, the activated elements of set S2u replace previously activated elements by earlier signaling of S2u.

In one example, set S2u is signaled as a field-map of Ku elements, wherein each field element signals an index from set S1. In one example, the size of the field map can be Ku×[log₂ L], where [log₂ L] is the size of each field element and Ku is the number of field elements. In one example, the order of the Ku elements in set S2u can be arranged in ascending order of index from set S1. In one example, the order of the Ku elements in set S2u can be arranged in descending order of index from set S1. In one example, the order of the Ku elements in set S2u can be arranged according to the order of corresponding elements in field map. In one example, the size of the field can be [Ku×log₂ L].

In one example, set S2u is signaled as a combinatorial index indicating Ku elements from set S1 with L elements. In one example, the size of the field map can be

$$⌈ {log}_{2} ( \begin{matrix}L \\ Ku\end{matrix} ) ⌉ .$$

In one example, the order of the Ku elements in set S2u can be arranged in ascending order of index from set S1. In one example, the order of the Ku elements in set S2u can be arranged in descending order of index from set S1.

In one example, the message conveying S2u can be a two-stage message, for the example, the first stage indicating the length or number of elements (e.g., Ku) signaled by the second stage and possibly one or more spatial resource units. In one example, the message conveying S2u is a single stage message and value of Ku is fixed (e.g., determined based on prior configuration or signaling). In one example, the message conveying S2u is a single stage message, and the value of Ku can vary (e.g., as indicated in the message).

In one example, the message conveying S2u is higher layer signaling, e.g., MAC CE signaling or RRC signaling. In one example, the message conveying S2u is L1 control signaling.

In one example, the UE activates the Ku spatial resource units of S2u. In one example, the Ku spatial resource units signaled in a message to BS (e.g., the BS 102) become activated a time T (or no later than a time T) from the message containing S2u. In one example, T is measured from the start of the message. In one example, T is measured from the end of the message. In one example, the Ku spatial resource units signaled in a message to BS become activated a time T (or no later than a time T) from the ACK to the message containing S2u. In one example, T is measured from the start of the message carrying the ACK. In one example, T is measured from the end of the message carrying the ACK. In one example, T can be configured or updated by SIB and/or RRC and/or MAC CE and/or L1 control (e.g., DCI Format) signaling. In the example, the ACK is carried by a DCI Format and/or in a PDCCH channel. In one example, T=0. In one example, the TCI state is activated when the UE signals the TCI state for activation.

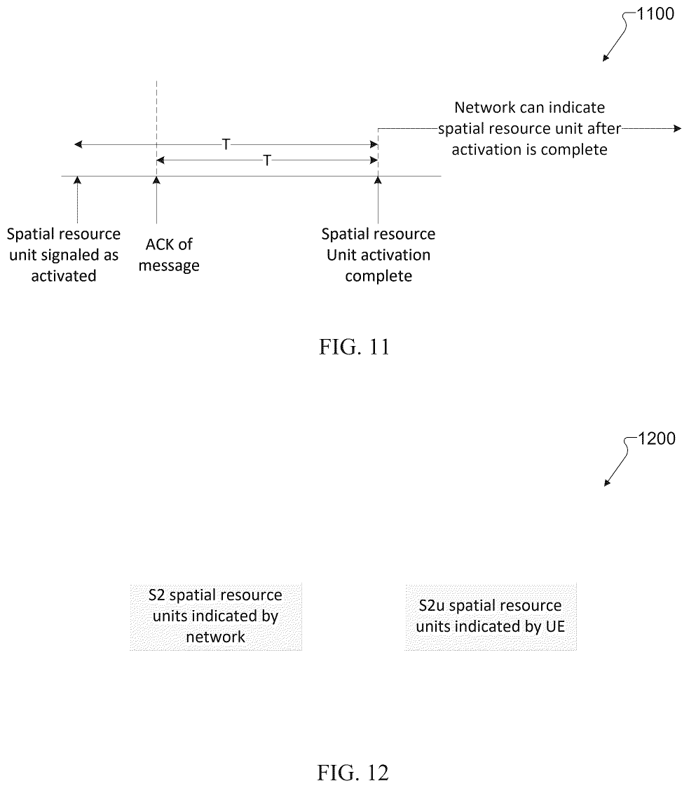

FIG. 11 illustrates a timeline 1100 for indicating/activating a spatial resource unit according to embodiments of the present disclosure. For example, timeline 1100 can be followed by the UE 112 and the network 130 and/or BS 102 in the wireless network 100 of FIG. 1. This example is for illustration only and other embodiments can be used without departing from the scope of the present disclosure.

In one example, as illustrated in FIG. 11, the UE signals a spatial resource unit (e.g., SRU1) to be activated to the network, e.g., in set S2u. In one example, the UE can complete the activation of the spatial resource unit at or after (or no later than) time T from the message containing set S2u. In one example, the UE can complete the activation of the spatial resource unit at or after (or no later than) time T from the ACK of the message containing set S2u. In one example, the network can send a message signaling the indication of SRU1 after the spatial resource unit pre-activation is complete as illustrated in FIG. 11. In the example, the ACK is carried by a DCI Format and/or in a PDCCH channel. In one example, T=0. In one example, the TCI state is activated when the UE signals the TCI state for activation.

In one example, if the network activates a spatial resource unit that the UE has not signaled for activation, the network can indicate the spatial resource unit after a time T1 from the message activating the spatial resource unit, or after a time T1 from the ACK of the message activating the spatial resource unit. In one example, if the network activates a spatial resource unit that the UE has signaled for activation, the network can indicate the spatial resource unit after a time T2 from the message activating the spatial resource unit, or after a time T2 from the ACK of the message activating the spatial resource unit. In one example, T1 and T2 can be different parameters. In one example, the network can configure and/or update T1 or T2 by SIB and/or RRC and/or MAC CE and/or L1 control (e.g., DCI Format) signaling. In the example, the ACK is carried by a UCI Format and/or in a PUCCH or PUSCH channel. In one example, T2=0. In one example, the TCI state is activated when the UE signals the TCI state for activation.

In one example, the UE deactivates Ku spatial resource units from set S2u and replaces them with Ku spatial resource units from set S1. The deactivated spatial resource units can be signaled as set S2d with Ku elements and activated spatial resource units can be signaled as set S2u with Ku elements.

In one example, set S2d is signaled as a field-map of Ku elements, wherein each field element signals an index from set S2 to be deactivated. In one example, the size of the field map can be Ku×[log₂ K], where [log₂ K] is the size of each field element and Ku is the number of field elements. In variant example, the signaled field elements for deactivation can be from set S1 (e.g., corresponding to elements that are activated in set S2), the size of the field map can be Ku×[log₂ L]. In one example, the size of the field can be [Ku×log₂ K]. In one example, the size of the field can be [Ku×log₂ L]. In one example, set S2d is signaled as a bitmap of K bits, wherein each bit signals whether or not to deactivated a corresponding element of S2. In one example, a bit with value 0 signals that the corresponding element is deactivated and a bit with value 1 signals that the corresponding element is not deactivated. In one example, a bit with value 0 signals that the corresponding element is not deactivated and a bit with value 1 signals that the corresponding element is deactivated.

In one example, S2u is signaled as a field-map of Ku elements as mentioned herein, an element in the field-map that is activated replaces the previously activated spatial resource unit corresponding to the same element of the field-map (if any), e.g., the previously activated spatial resource unit corresponding to the same element of the field-map is deactivated, and replaced by the newly activated spatial resource element in the corresponding element of the field-map.

In one example, set S2d is signaled as a combinatorial index indicating Ku elements from set S2 with K elements to be deactivated. In one example, the size of the field map can be

$$⌈ {log}_{2} ( \begin{matrix}K \\ Ku\end{matrix} ) ⌉ .$$

In variant example, the signaled field elements for deactivation can be from set S1 (e.g., corresponding to elements that are activated in set S2), the size of the field map can be

$$⌈ {log}_{2} ( \begin{matrix}L \\ Ku\end{matrix} ) ⌉ .$$

In one example, set S2u is signaled as a field-map of Ku elements, wherein each field element signals an index from set S1. In one example, the size of the field map can be Ku×[log₂ L], where [log₂ L] is the size of each field element and Ku is the number of field elements. In one example, the order of the K elements in set S2 after deactivation and activation can be the activated elements arranged in ascending order of index from set S1. In one example, the order of the K elements in set S2 after deactivation and activation can be the activated elements arranged in descending order of index from set S1. In one example, the order of the Ku elements in set S2u can be arranged according to the order of corresponding elements in field map based on the deactivated spatial resource units and spatial resource unit activated to replace the deactivated spatial resource units. In one example, the size of the field can be [Ku×log₂ L].

In one example, set S2u is signaled as a combinatorial index indicating Ku elements from set S1 with L elements. In one example, the size of the field map can be

$$⌈ {log}_{2} ( \begin{matrix}L \\ Ku\end{matrix} ) ⌉ .$$

In one example, the order of the K elements in set S2 after deactivation and activation can be the activated elements arranged in ascending order of index from set S1. In one example, the order of the K elements in set S2 after deactivation and activation can be the activated elements arranged in descending order of index from set S1.

In one example, the message conveying S2d and S2u can be a two-stage message, for the example, the first stage indicating the length or number of elements (e.g., Ku) signaled by the second stage and possibly one or more spatial resource units. In one example, the message conveying S2d and S2u is a single stage message and value of Ku is fixed (e.g., determined based on prior configuration or signaling). In one example, the message conveying S2d and S2u is a single stage message, and the value of Ku can vary (e.g., as indicated in the message).

In one example, the message conveying S2d and S2u is higher layer signaling, e.g., MAC CE signaling or RRC signaling. In one example, the message conveying S2d and S2u is L1 control signaling.

In one example, the UE activates the Ku spatial resource units of S2u. In one example, the Ku spatial resource units signaled in a message to BS become activated a time T (or no later than a time T) from the message containing S2u. In one example, T is measured from the start of the message. In one example, T is measured from the end of the message. In one example, the Ku spatial resource units signaled in a message to BS become activated a time T (or no later than a time T) from the ACK to the message containing S2u. In one example, T is measured from the start of the message carrying the ACK. In one example, T is measured from the end of the message carrying the ACK. In one example, T can be configured or updated by SIB and/or RRC and/or MAC CE and/or L1 control (e.g., DCI Format) signaling. In the example, the ACK is carried by a DCI Format and/or in a PDCCH channel. In one example, T=0. In one example, the TCI state is activated when the UE signals the TCI state for activation.

In one example, the UE signals a spatial resource unit (e.g., SRU1) to be activated to the network, e.g., in set S2u. In one example, the UE can complete the activation of the spatial resource unit at or after (or no later than) time T from the message containing set S2u. In one example, the UE can complete the activation of the spatial resource unit at or after (or no later than) time T from the ACK of the message containing set S2u. In one example, the network (e.g., the network 130) can send a message signaling the indication of SRU1 after the spatial resource unit activation is complete. In the example, the ACK is carried by a DCI Format and/or in a PDCCH channel. In one example, T=0. In one example, the TCI state is activated when the UE signals the TCI state for activation.

In one example, if the network activates a spatial resource unit that the UE has not signaled for activation, the network can indicate the spatial resource unit after a time T1 from the message activating the spatial resource unit, or after a time T1 from the ACK of the message activating the spatial resource unit. In one example, T1 can be different parameters. In one example, the network can configure and/or update T1 or T2 by SIB and/or RRC and/or MAC CE and/or L1 control (e.g., DCI Format) signaling. In the example, the ACK is carried by a UCI Format and/or in a PUCCH or PUSCH channel. In one example, T2=0. In one example, the TCI state is activated when the UE signals the TCI state for activation.

In one example, the deactivated spatial resource units in S2d don't include currently indicated spatial resource units. In one example, at least one currently indicated spatial resource unit is not included in S2d. In one example, there is no restriction on including currently indicated spatial resource units in S2d.

In one example, the maximum number of spatial resource units that can be deactivated and re-activated with a new spatial resource unit is Ku_max. In one example Ku_max depends on a UE capability. In one example, Ku_max can be defined in the system specifications and/or configured or updated by SIB and/or RRC and/or MAC and/or L1 control (e.g., DCI Format) signaling.
In one example of the following, when a single set S3 is indicated, S3 and S3u and S3d (described later) are signaled from the elements of set S2, where S2 can be activated as a single set or created from two activated sets (S21 and S22) as described herein (example B1 FIG. 8(B)).
In one example of the following, when two sets (S31 and S32) are indicated, S3 and S3u and S3d (described later) signaled from the elements of S2 can correspond to one of:
   S31 and S31u and S31d signaled from the elements of S21.
   S32 and S32u and S32d signaled from the elements of S22.

### Where;

S31u is the set of spatial resource units to be indicated (by UE) or recommended for indication from UE to the network corresponding to the first set of activated spatial resource units S21, indicated TCI states refer to TCI states that will be applied for reception or transmission at the UE or at the BS, and
S31d is the set of indicated spatial resource units to be de-indicated (by UE) or recommended for de-indication to the network corresponding to the first set of activated spatial resource units S21, de-indicated TCI states refer to TCI states that will no longer be applied for reception or transmission at the UE or at the BS, and
S32u is the set of spatial resource units to be indicated (by UE) or recommended for indication by UE to the network corresponding to the second set of activated spatial resource units S22, and
S32d is the set of indicated spatial resource units to be de-indicated (by UE) or recommended for de-indication by UE to the network corresponding to the second set of activate spatial resource units S22.

In one example, the UE signals to the network a set S3u of spatial resource units with Mu elements for indication. The network can update elements of set S3 based on set S3u (or some of the elements of set S3u) from the UE.

In one example, set S3u is signaled as a field-map of Mu elements, wherein each field element signals an index from set S2. In one example, the size of the field map can be Mu×[log₂ K], where [log₂ K] is the size of each field element and Mu is the number of field elements. In one example, the order of the Mu elements in set S3u can be arranged in ascending order of index from set S2 or from set S1. In one example, the order of the Mu elements in set S3u can be arranged in descending order of index from set S2 or from set S1. In one example, the order of the Mu elements in set S2u can be arranged according to the order of corresponding elements in field map. In one example, the size of the field can be [Mu×log₂ K].

In one example, set S3u is signaled as a combinatorial index indicating Mu elements from set S2 with K elements. In one example, the size of the field map can be

$$⌈ {log}_{2} ( \begin{matrix}K \\ Mu\end{matrix} ) ⌉ .$$

In one example, the order of the Mu elements in set S3u can be arranged in ascending order of index from set S2 or from set S1. In one example, the order of the Mu elements in set S3u can be arranged in descending order of index from set S2 or form set S1.

In one example, the message conveying S3u can be a two-stage message, for example, the first stage indicating the length or number of elements (e.g., Mu) signaled by the second stage and possibly one or more spatial resource units. In one example, the message conveying S3u is a single stage message and value of Mu is fixed (e.g., determined based on prior configuration or signaling). In one example, the message conveying S3u is a single stage message, and the value of Mu can vary (e.g., as indicated in the message).

In one example, the message conveying S3u is higher layer signaling, e.g., MAC CE signaling or RRC signaling. In one example, the message conveying S3u is L1 control signaling.

In one example, the UE (e.g., the UE 116) can signal Mu spatial resource units from set S3 for de-indication as set S3d. The network can de-indicate elements of set S3 based on set S3d (or some of the elements of set S3d) from the UE. In one example, the elements of set S3 can be arranged in descending or ascending order of spatial resource unit index. In one example, the spatial resource unit index is determined by index (or order) of spatial resource unit in set S2 or in set S1, e.g., ascending order. In one example, the spatial resource unit index is determined by index (or order) of spatial resource unit in set S2 or in set S1, e.g., descending order. In one example, the spatial resource unit index can be determined by the order of a field map indicating S3.

In one example, set S3d is signaled as a field-map of Mu elements, wherein each field element signals an index from set S2 to be de-indicated. In one example, the size of the field map can be Mu×[log₂ M], where [log₂ M] is the size of each field element and Mu is the number of field elements. Wherein, M is the size of set S3. In a variant example, the signaled field elements for de-indicate can be from set S2 (e.g., corresponding to elements that are indicated in set S3), the size of the field map can be Mu×[log₂ K]. In one example, the size of the field can be [Mu×log₂ M]. In one example, the size of the field can be [Mu×log₂ K]. In one example, set S3d is signaled as a bitmap of M bits, wherein each bit signals whether or not to de-indicate a corresponding element of S3. In one example, a bit with value 0 signals that the corresponding element is de-indicated and a bit with value 1 signals that the corresponding element is not de-indicated. In one example, a bit with value 0 signals that the corresponding element is not de-indicated and a bit with value 1 signals that the corresponding element is de-indicated. In one example, a de-indicated spatial resource unit is a spatial resource unit that is to no longer be applied.

In one example, set S3d is signaled as a combinatorial index indicating Mu elements from set S3 with M elements to be de-indicated. In one example, the size of the field map can be

$$⌈ {log}_{2} ( \begin{matrix}M \\ Mu\end{matrix} ) ⌉ .$$

In variant example, the signaled field elements for de-indication can be from set S2 (e.g., corresponding to elements that are indicated in set S3), the size of the field map can be

$$⌈ {log}_{2} ( \begin{matrix}K \\ Mu\end{matrix} ) ⌉ .$$

In one example, the message conveying S3d can be a two-stage message, for example, the first stage indicating the length or number of elements (e.g., Mu) signaled by the second stage and possibly one or more spatial resource units. In one example, the message conveying S3d is a single stage message and value of Mu is fixed (e.g., determined based on prior configuration or signaling). In one example, the message conveying S3d is a single stage message, and the value of Mu can vary (e.g., as indicated in the message).

In one example, the message conveying S3d is higher layer signaling, e.g., MAC CE signaling or RRC signaling. In one example, the message conveying S3d is L1 control signaling.

In one example, the UE can signal Mu spatial resource units from set S3 for de-indication as set S3d, and Mu spatial resource units from set S2 for indication. The network can de-indicate and indicate elements of set S3 based on sets S3d and S3u (or some of the elements of sets S3d and S3u) from the UE. The signaling for indication and de-indication can be as described herein.

In one example, the message conveying S3u and S3d can be a two-stage message, for example, the first stage indicating the length or number of elements (e.g., Mu) signaled by the second stage and possibly one or more spatial resource units for activation and/or deactivation. In one example, the message conveying S3u and S3d is a single stage message and value of Mu is fixed (e.g., determined based on prior configuration or signaling). In one example, the message conveying S3u and S3d is a single stage message, and the value of Mu can vary (e.g., as indicated in the message).

In one example, the message conveying S3u and S3d is higher layer signaling, e.g., MAC CE signaling or RRC signaling. In one example, the message conveying S2u and S2d is L1 control signaling.

FIG. 12 illustrates examples of spatial resource units 1200 according to embodiments of the present disclosure. For example, spatial resource units 1200 can be indicated by the UE 115 and/or the network 130 and/or BS 102 in the wireless network 100 of FIG. 1. This example is for illustration only and other embodiments can be used without departing from the scope of the present disclosure.

In one example, the UE applies and signals to the network a set S3u of spatial resource units with Mu elements. The set S3u of indicated (applied) spatial resource units by the UE, can be in addition to set S3 of indicated spatial resource units by the network as illustrated in FIG. 12. In one example, the BS (e.g., the BS 102) can update set S3 based on set S3u or some of the elements of set S3u. In one example, the indicated (applied) elements of set S3u replace previously indicated (applied) elements by earlier signaling of S3u.

In one example, set S3u is signaled as a field-map of Mu elements, wherein each field element signals an index from set S2. In one example, the size of the field map can be Mu×[log₂ K], where [log₂ K] is the size of each field element and Mu is the number of field elements. In one example, the order of the Mu elements in set S3u can be arranged in ascending order of index from set S2 or from set S1. In one example, the order of the Mu elements in set S3u can be arranged in descending order of index from set S2 or from set S1. In one example, the order of the Mu elements in set S3u can be arranged according to the order of corresponding elements in field map. In one example, the size of the field can be [Mu×log₂ K].

In one example, set S2u is signaled as a combinatorial index indicating Mu elements from set S2 with K elements. In one example, the size of the field map can be

$$⌈ {log}_{2} ( \begin{matrix}K \\ Mu\end{matrix} ) ⌉ .$$

In one example, the order of the Mu elements in set S3u can be arranged in ascending order of index from set S2 or from set S1. In one example, the order of the Mu elements in set S3u can be arranged in descending order of index from set S2 or from set S1.

In one example, the message conveying S2u can be a two-stage message, for the example, the first stage indicating the length or number of elements (e.g., Mu) signaled by the second stage and possibly one or more spatial resource units. In one example, the message conveying S2u is a single stage message and value of Mu is fixed (e.g., determined based on prior configuration or signaling). In one example, the message conveying S2u is a single stage message, and the value of Mu can vary (e.g., as indicated in the message).

In one example, the message conveying S3u is higher layer signaling, e.g., MAC CE signaling or RRC signaling. In one example, the message conveying S3u is L1 control signaling.

In one example, the UE indicates (applies) the Mu spatial resource units of S3u. In one example, the Mu spatial resource units signaled in a message to BS become indicated (applied) a time T (or no later than a time T) from the message containing S3u. In one example, T is measured from the start of the message. In one example, T is measured from the end of the message. In one example, the Mu spatial resource units signaled in a message to BS become indicated (applied) a time T (or no later than a time T) from the ACK to the message containing S3u. In one example, T is measured from the start of the message carrying the ACK. In one example, T is measured from the end of the message carrying the ACK. In one example, T can be configured or updated by SIB and/or RRC and/or MAC CE and/or L1 control (e.g., DCI Format) signaling. In the example, the ACK is carried by a DCI Format and/or in a PDCCH channel.

In one example, the UE de-indicates Mu spatial resource units from set S3u and replaces them with Mu spatial resource units from set S2. The de-indicated spatial resource units can be signaled as set S3d with Mu elements and indicated spatial resource units can be signaled as set S3u with Mu elements.

In one example, set S3d is signaled as a field-map of Mu elements, wherein each field element signals an index from set S2 to be deactivated. In one example, the size of the field map can be Mu×[log₂ M], where [log₂ M] is the size of each field element and Mu is the number of field elements. In variant example, the signaled field elements for de-indication can be from set S2 (e.g., corresponding to elements that are indicated in set S3), the size of the field map can be Mu×[log₂ K]. In one example, the size of the field can be [Mu×log₂ M]. In one example, the size of the field can be [Mu×log₂ K]. In one example, set S3d is signaled as a bitmap of M bits, wherein each bit signals whether or not to de-indicated a corresponding element of S3. In one example, a bit with value 0 signals that the corresponding element is de-indicated and a bit with value 1 signals that the corresponding element is not de-indicated. In one example, a bit with value 0 signals that the corresponding element is not de-indicated and a bit with value 1 signals that the corresponding element is de-indicated.

In one example, S3u is signaled as a field-map of Mu elements as mentioned herein, an element in the field-map that is indicated replaces the previously indicated spatial resource unit corresponding to the same element of the field-map (if any), e.g., the previously indicated spatial resource unit corresponding to the same element of the field-map is de-indicated (de-applied), and replaced by the newly indicated spatial resource element in the corresponding element of the field-map.

In one example, set S3d is signaled as a combinatorial index indicating Mu elements from set S3 with M elements to be deactivated. In one example, the size of the field map can be

$$⌈ {log}_{2} ( \begin{matrix}M \\ Mu\end{matrix} ) ⌉ .$$

In variant example, the signaled field elements for de-indication can be from set S2 (e.g., corresponding to elements that are indicated in set S3), the size of the field map can be

$$⌈ {log}_{2} ( \begin{matrix}K \\ Mu\end{matrix} ) ⌉ .$$

In one example, set S3u is signaled as a field-map of Mu elements, wherein each field element signals an index from set S2. In one example, the size of the field map can be Mu×[log₂ K], where [log₂ K] is the size of each field element and Mu is the number of field elements. In one example, the order of the M elements in set S3 after de-indication and indication can be the indicated (applied) elements arranged in ascending order of index from set S2 or from set S1. In one example, the order of the M elements in set S3 after de-indication and indication can be the indicated (applied) elements arranged in descending order of index from set S2 or from set S1. In one example, the order of the Mu elements in set S3u can be arranged according to the order of corresponding elements in field map based on the de-indicated spatial resource units and spatial resource unit indicated to replace the de-indicated spatial resource units. In one example, the size of the field can be [Mu×log₂ K]

In one example, set S3u is signaled as a combinatorial index indicating Mu elements from set S2 with K elements. In one example, the size of the field map can be

$$⌈ {log}_{2} ( \begin{matrix}K \\ Mu\end{matrix} ) ⌉ .$$

In one example, the order of the M elements in set S3 after de-indication and indication can be the indicated elements arranged in ascending order of index from set S2 or from set S1. In one example, the order of the M elements in set S3 after de-indication and indication can be the indicated elements arranged in descending order of index from set S2 or from set S1.

In one example, the message conveying S3d and S3u can be a two-stage message, for the example, the first stage indicating the length or number of elements (e.g., Mu) signaled by the second stage and possibly one or more spatial resource units. In one example, the message conveying S3d and S3u is a single stage message and value of Mu is fixed (e.g., determined based on prior configuration or signaling). In one example, the message conveying S3d and S3u is a single stage message, and the value of Mu can vary (e.g., as indicated in the message).

In one example, the message conveying S3d and S3u is higher layer signaling, e.g., MAC CE signaling or RRC signaling. In one example, the message conveying S3d and S3u is L1 control signaling.

In one example, the UE indicates (applies) the Mu spatial resource units of S3u. In one example, the Mu spatial resource units signaled in a message to BS become indicated (applied) a time T (or no later than a time T) from the message containing S3u. In one example, T is measured from the start of the message. In one example, T is measured from the end of the message. In one example, the Mu spatial resource units signaled in a message to BS become indicated (applied) a time T (or no later than a time T) from the ACK to the message containing S3u. In one example, T is measured from the start of the message carrying the ACK. In one example, T is measured from the end of the message carrying the ACK. In one example, T can be configured or updated by SIB and/or RRC and/or MAC CE and/or L1 control (e.g., DCI Format) signaling. In the example, the ACK is carried by a DCI Format and/or in a PDCCH channel.

In one example, the maximum number of spatial resource units that can be de-indicated (de-applied) and re-indicated (re-applied) with a new spatial resource unit is Mu_max. In one example Mu_max depends on a UE capability. In one example, Mu_max can be defined in the system specifications and/or configured or updated by SIB and/or RRC and/or MAC and/or L1 control (e.g., DCI Format) signaling.

In one example, the UE activates spatial resource units or recommends spatial resource units for activation in set S2u (e.g., FIG. 10) and indicates (applies) spatial resource units or recommends spatial resource units for indication (application) from set S2u in set S3u. In one example, the activation (or recommendation for activation) in S2u and the indication (or recommendation for indication) in S3u are in different messages. In one example, the activation (or recommendation for activation) in S2u and the indication (or recommendation for indication) in S3u are in a same message.

In one example, a UE can signal a set of spatial resource units recommended for activation in set S2u, and the UE signals a set of spatial resource units recommended for indication from S2u in first S3u. In another example, the UE can addition or alternatively signal a set of spatial resource units recommended for indication from S2 in a second S3u. In one example, all or some of the signaling mentioned herein of S2u, e.g., a first S3u and a second S3u can in a same message. In one example, the signaling of S2u mentioned herein, e.g., a first S3u and a second S3u in can in separate messages.

In one example, the UE can signal S2d, activated spatial resource units to deactivate, and S2u new spatial resource units to activate. Let “S2_current” be the current set of activated spatial resource units. Let “S2_recommended” be the recommended set of activated spatial resource unit, wherein, S2_recommended=S2_current−S2d+S2u. In one example, the UE can signal spatial resource units for indication or recommendations for spatial resource units to indicate (e.g., S3u) with S2u and/or S2d. In one example, S3u is based on “S2_current”. In one example, S3u is based on “S2_recommended”. In one example, the UE can signal recommendations for spatial resource unit to de-indicate (e.g., S3d) with S2u and/or S2d. In one example, S3d is based on “S2_current”. In one example, S3d is based on “S2_recommended”.

As described in 38.133 section 8.15.5, when a TCI is activated in slot n by a MAC CE activation command; if the target TCI states in the active TCI state list are known, upon receiving PDSCH carrying MAC-CE active TCI state list update at slot n, UE shall have completed the TCI state list update in slot:

$$n + {T}_{HARQ} + 3 {N}_{slot}^{subframe , μ} + {TO}_{k} \frac{( {T}_{first - SSB \_ List} + {T}_{SSB - proc} )}{NR slot length} .$$

If a subset of the target TCI states in the active TCI state list are unknown, upon receiving PDSCH carrying MAC-CE active TCI state list update at slot n, UE shall have completed the TCI state list update in slot:

$$n + {T}_{HARQ} + 3 {N}_{slot}^{subframe , μ} + \frac{{T}_{L 1 - {RSRP}_{List}} + {TO}_{uk} ( {T}_{first - {SSB}_{List}} + {T}_{SSB - proc} )}{NR slot length} .$$

For UL TCI state activation, as described in TS 38.133 clause 8.16.5, if the target TCI states in the active TCI state list are known, upon receiving PDSCH carrying MAC-CE active TCI state list update at slot n, UE shall have completed the TCI state list update in slot:

$$n + {T}_{HARQ} + 3 {N}_{slot}^{subframe , μ} + \frac{NM ( {T}_{first \_ target - PL - RS \_ List} + 4 * {T}_{target \_ PL - RS \_ List} + 2 ms )}{NR slot length} .$$

If a subset of target TCI states in the active TCI state list are unknown, upon receiving PDSCH carrying MAC-CE active TCI state list update at slot n, UE shall have completed the TCI state list update in slot:

$$n + {T}_{HARQ} + 3 {N}_{slot}^{subframe , μ} + \frac{\begin{matrix}NM ( {T}_{L 1 - RRSRP \_ List} + \\ {T}_{first \_ target - PL - RS \_ List} + 4 * {T}_{target \_ PL - RS \_ List} + 2 ms )\end{matrix}}{NR slot length} .$$

### In the Equations Herein as Described in TS 38.133:

T_{HARQ} is the time between the DL data transmission and the corresponding acknowledgment.

$${N}_{slot}^{subframe , μ}$$

is the number of slots in a subframe (of duration 1 ms) for numerology μ.
T_{L1-RSRP_list} is the longest L1 measurement time (T_{L1-RSRP}) of the source RS among the unknown target TCI states. T_{L1-RSRP} is the time for L1 RSRP measurement for Rx beam refinement as defined in TS 38.133 clause 8.15.3.
T_{first-SSB_List} depends on the number cells associated with target TCI states in the TCI state active list as described in TS 38.133 clause 8.15.5
T_{SSB-proc} is the SSB processing time which equals 2 ms.

The downlink TCI state is known if the following conditions are met (TS 38.133 clause 8.15.2):
During the period from the last transmission of the RS resource used for the L1-RSRP measurement reporting for the target downlink TCI state to the completion of active downlink TCI state switch, where the RS resource for L1-RSRP measurement is the RS in target downlink TCI state or QCLed to the target downlink TCI state
Downlink TCI state switch command is received within 1280 ms upon the last transmission of the RS resource for beam reporting or measurement
The UE has sent at least 1 L1-RSRP report for the target downlink TCI state before the downlink TCI state switch command
The target downlink TCI state remains detectable during the downlink TCI state switching period
The SSB associated with the downlink TCI state remain detectable during the downlink TCI switching period
   signal-to-noise ratio (SNR) of the downlink TCI state ≥−3 dB
   The SSB can be associated with either the serving cell PCI or a PCI different from serving cell PCI.

Otherwise, the downlink TCI state is unknown.

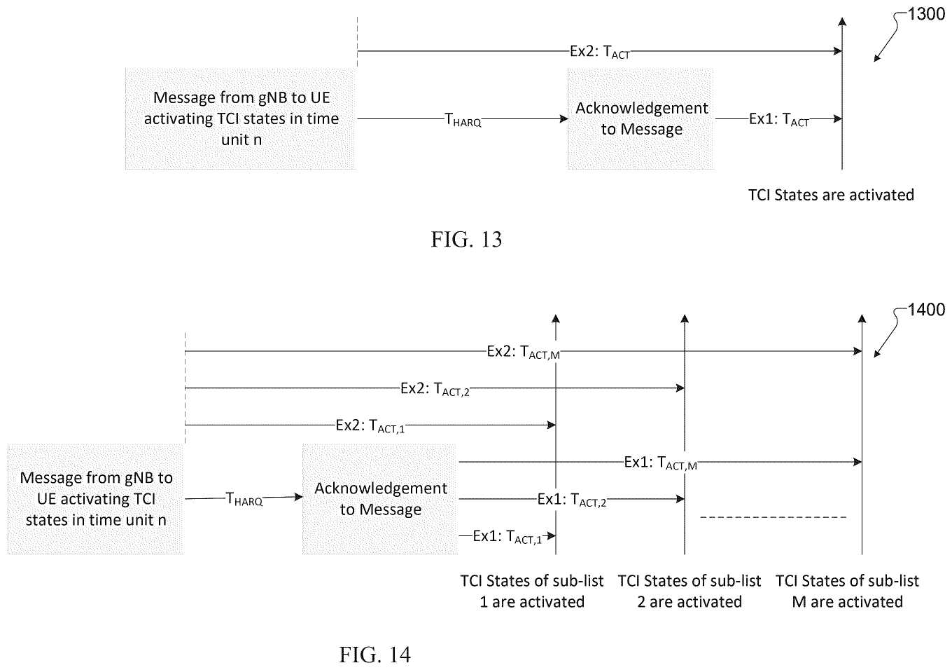

FIG. 13 illustrates a timeline 1300 for activating transmission configuration indication (TCI) states according to embodiments of the present disclosure. For example, timeline 1300 can be followed by the UE 114 and the BS 102 and/or network 130 in the wireless network 100 of FIG. 1. This example is for illustration only and other embodiments can be used without departing from the scope of the present disclosure.

Based on what is mentioned herein, the activation time of TCI states depends on the status of the TCI states, (e.g., whether the TCI states are known or not, and number of cells associated with TCI states, etc.).

In one example, TCI states become active at a same time, the time is determined based on the worst case condition (e.g., longest activation time) among the activation time of the TCI states in the list of TCI states being activated as illustrated in FIG. 13.

In FIG. 13, a message transmitted from the BS to the UE activating a list of TCI states.
In one example, the message activating a list TCI states is L1 control message (e.g., DCI Format in PDCCH, or L1 control information in PDSCH).
In one example, the message activating a list TCI states is MAC CE or ANS.1 message in a PDSCH.
In one example, the message activating a list of TCI states includes TCI states in a cell, e.g., serving cell or a cell with PCI different from the PCI of the serving cell.
In one example, the message activating a list of TCI states can include TCI states from more than one cell, e.g., a serving cell and a cell(s) with a PCI different from the PCI of the serving cell.
In one example, a time unit is a slot.

In one example of FIG. 13, an acknowledgment is transmitted in response to the message from BS to the UE activating a list of TCI states. In one example, the acknowledgment is transmitted in a physical uplink control channel (PUCCH) or similar channel in 6G. In one example, the acknowledgment is transmitted in a physical uplink shared channel (PUSCH) or similar channel in 6G. In one example, if PUCCH overlaps a PUSCH, the acknowledgment is transmitted in the PUSCH and the PUCCH is not transmitted.

In one example, the acknowledgment is transmitted in an uplink channel at or after a time T_{HARQ} from the DL message from BS to the UE (e.g., the UE 116) activating a list of TCI states. In one example, T_{HARQ} is signaled in a DCI Format associated with the DL message. In one example, T_{HARQ} is in number of slots, e.g., is acknowledgment transmitted in an UL slot that is T_{HARQ} after slot of the DL message activating a list TCI states. In one example, T_{HARQ} is in symbols and/or slots and/or sub-frames and/or frames from the start or end of the DL channel (e.g., PDCCH or PDSCH) carrying the DL message activating a list of TCI states (or time-unit (e.g., symbol/slot/subframe/frame) of DL channel) to start or end of the UL channel (e.g., PUCCH or PUSCH) carrying the acknowledgment to the DL message (or time-unit (e.g., symbol/slot/subframe/frame) of UL channel).

In one example of FIG. 13, there is no acknowledgment for the message from BS to the UE activating a list of TCI states.

In one example of FIG. 13, activation time for the list of TCI states is determined by the BS and by the UE, there is one activation time for the TCI states in the list the activation time is determined based on the longest activation time of the TCI states in the list of TCI states (e.g., based on TCI states with unknown state if any, and based on a cell with longest SS/PBCH block period, or with latest SS/PBCH block time from the message activating TCI states or from the acknowledgment to the message activating TCI states).

In one example, of FIG. 13, the activation time T_{ACT} is measured from the channel carrying the acknowledgement to DL message, (Ex1) in FIG. 13. In one example, T_{ACT} is in number of slots, e.g., the TCI state(s) are activated in a slot that starts T_{ACT} after slot of the acknowledgment. In one example, T_{ACT} is in symbols and/or slots and/or sub-frames and/or frames from the start or end of the UL channel (e.g., PUCCH or PUSCH) carrying the acknowledgment (or time-unit (e.g., symbol/slot/subframe/frame) of UL channel) to start or end of the time-unit (e.g., symbol/slot/subframe/frame) where the TCI state(s) are activated.

In one example, of FIG. 13, the activation time T_{ACT} is measured from the channel carrying the DL message activating a list of TCI states, (Ex2) in FIG. 13. In one example, T_{ACT} is in number of slots, e.g., the TCI state(s) are activated in a slot that starts T_{ACT} after slot of the DL message activating a list of TCI states. In one example, T_{ACT} is in symbols and/or slots and/or sub-frames and/or frames from the start or end of the DL channel (e.g., PDCCH or PDSCH) carrying the DL message activating a list of TCI states (or time-unit (e.g., symbol/slot/subframe/frame) of DL channel) to start or end of the time-unit (e.g., symbol/slot/subframe/frame) where the TCI state(s) are activated. In one example, there is no acknowledgment to the DL message activating a list of TCI states. In variant example, there is an acknowledgment to the DL message activating a list of TCI states.

FIG. 14 illustrates a timeline 1400 for activating TCI states according to embodiments of the present disclosure. For example, timeline 1400 can be followed by the UE 114 and the BS 102 and/or network 130 in the wireless network 100 of FIG. 1. This example is for illustration only and other embodiments can be used without departing from the scope of the present disclosure.

In one example, T_{ACT,i} as mentioned herein, is determined by the BS (e.g., the BS 102) and UE based on rules. In one example, T_{ACT} is determined by the UE and signaled to the BS in an UL message. In one example, T_{ACT} is included with the acknowledgment to the DL message activating TCI states in a same message (or same UL channel). In one example, T_{ACT} and the acknowledgment to the DL message activating TCI states are included in separate messages (separate UL channels). In one example, there are N code points for T_{ACT,i} e.g., based on RRC configuration and one of the N codepoints is signaled from the UE to BS, e.g., using a field of size [log₂ N]. In one example, N=2.

In one example, TCI states can become active at different times, the time is determined based on the of the TCI state, e.g., whether it is known or not and based on the cell of the TCI state. In a first variant, e.g., each TCI state has its activation time. In a second variant, a first sub-list (or first subset) of the list of TCI states has a first activation time, a second sub-list (or second subset) of the list of TCI states has a second activation, . . . , an Mth sub-list (or Mth subset) of the list of TCI states has an Mth activation time, as illustrated in FIG. 14. In one example, each sub-list or subset has one TCI state. In one example, M=2.

In FIG. 14, a message transmitted from the BS to the UE activating a list of TCI states.
In one example, the message activating a list TCI states is L1 control message (e.g., DCI Format in PDCCH, or L1 control information in PDSCH).
In one example, the message activating a list TCI states is MAC CE or ANS.1 message in a PDSCH.
In one example, the message activating a list of TCI states includes TCI states in a cell, e.g., serving cell or a cell with PCI different from the PCI of the serving cell.
In one example, the message activating a list of TCI states can include TCI states from more than one cell, e.g., a serving cell and a cell(s) with a PCI different from the PCI of the serving cell.
In one example, the grouping of TCI states into sub-lists or subsets in signaled in the DL message activating TCI states.
In one example, there is no grouping of TCI states into sub-lists or subsets in the DL message activating TCI states.
In one example, the UE groups the TCI states into sub-lists or subsets based on activation delay of TCI states. For example, TCI states with the same or similar activation delay are group together.
In one example, a time unit is a slot.

In one example of FIG. 14, an acknowledgment is transmitted in response to the message from BS to the UE activating a list of TCI states. In one example, the acknowledgment is transmitted in a physical uplink control channel (PUCCH) or similar channel in 6G. In one example, the acknowledgment is transmitted in a physical uplink shared channel (PUSCH) or similar channel in 6G. In one example, if PUCCH overlaps a PUSCH, the acknowledgment is transmitted in the PUSCH and the PUCCH is not transmitted.

In one example, the acknowledgment is transmitted in an uplink channel at or after a time T_{HARQ} from the DL message from BS to the UE activating a list of TCI states. In one example, T_{HARQ} is signaled in a DCI Format associated with the DL message. In one example, T_{HARQ} is in number of slots, e.g., is acknowledgment transmitted in an UL slot that is T_{HARQ} after slot of the DL message activating a list TCI states. In one example, T_{HARQ} is in symbols and/or slots and/or sub-frames and/or frames from the start or end of the DL channel (e.g., PDCCH or PDSCH) carrying the DL message activating a list of TCI states (or time-unit (e.g., symbol/slot/subframe/frame) of DL channel) to start or end of the UL channel (e.g., PUCCH or PUSCH) carrying the acknowledgment to the DL message (or time-unit (e.g., symbol/slot/subframe/frame) of UL channel).

In one example of FIG. 14, there is no acknowledgment for the message from BS to the UE activating a list of TCI states.

In one example of FIG. 14, activation times for the list of TCI states is determined by the BS and by the UE, there is an activation time for each TCI state in the list (e.g., the activation time is determined based on the status of the TCI state, and based on a cell of the TCI state).

In one example of FIG. 14, activation times for the list of TCI states is determined by the BS and by the UE, there is an activation time for each sub-list (or subset) of TCI state in the list the activation time for each sub-list or subset of TCI states is determined based on the longest activation time of the TCI states in the sub-list (or subset) of TCI states (e.g., the activation time is determined based on TCI states with unknown state if any, and based on a cell with longest SS/PBCH block period, or with latest SS/PBCH block time from the message activating TCI states or from the acknowledgment to the message activating TCI states). In one example, the grouping of TCI states into sub-lists (or subsets) is signaled by the BS to the UE (e.g., DL message activating TCI states). In one example, the grouping of TCI states into sub-lists (or subsets) is determined based on the TCI states that have the same or similar activating latency. In one example, the grouping of TCI states into sub-lists (or subsets) is signaled by the UE to the BS, e.g., using a message initiated by the UE or included in the message carrying the acknowledgment.

In one example, of FIG. 14, the activation time T_{ACT,i}, for TCI state i or for TCI state sub-list (or subset) i, is measured from the channel carrying the acknowledgement to DL message, (Ex1) in FIG. 14. Wherein, i=1, 2, . . . , M, and M is the number of TCI states, or the number of sub-lists (or subsets) of TCI states. In one example, T_{ACT,i} is in number of slots, e.g., the TCI state(s) are activated in a slot that starts T_{ACT,i} after slot of the acknowledgment. In one example, T_{ACT,i} is in symbols and/or slots and/or sub-frames and/or frames from the start or end of the UL channel (e.g., PUCCH or PUSCH) carrying the acknowledgment (or time-unit (e.g., symbol/slot/subframe/frame) of UL channel) to start or end of the time-unit (e.g., symbol/slot/subframe/frame) where the TCI state or sub-set of TCI states are activated.

In one example, of FIG. 14, the activation time T_{ACT,i}, for TCI state i or for TCI state sub-list (or subset) i, is measured from the channel carrying the DL message activating a list of TCI states, (Ex2) in FIG. 14. Wherein, i=1, 2, . . . , M, and M is the number of TCI states, or the number of sub-lists (or subsets) of TCI states. In one example, T_{ACT,i} is in number of slots, e.g., the TCI state(s) are activated in a slot that starts T_{ACT,i} after slot of the DL message activating a list of TCI states. In one example, T_{ACT,i} is in symbols and/or slots and/or sub-frames and/or frames from the start or end of the DL channel (e.g., PDCCH or PDSCH) carrying the DL message activating a list of TCI states (or time-unit (e.g., symbol/slot/subframe/frame) of DL channel) to start or end of the time-unit (e.g., symbol/slot/subframe/frame) where the TCI state or sub-list (or subset) of TCI states are activated. In one example, there is no acknowledgment to the DL message activating a list of TCI states. In variant example, there is an acknowledgment to the DL message activating a list of TCI states.

In one example, T_{ACT,i}, as mentioned herein, is determined by the BS and UE based on rules. In one example, T_{ACT,i} is determined by the UE and signaled to the BS in an UL message. In one example, T_{ACT,i} is included with the acknowledgment to the DL message activating TCI states in a same message (or same UL channel). In one example, T_{ACT,i} and the acknowledgment to the DL message activating TCI states are included in separate messages (separate UL channels). In one example, there are N code points for T_{ACT,i}, e.g., based on RRC configuration and one of the N codepoints is signaled from the UE to BS for each TCI state i, or for each sub-list (or subset) of TCI states, e.g., using a field of size [log₂ N]. In one example, N=2.

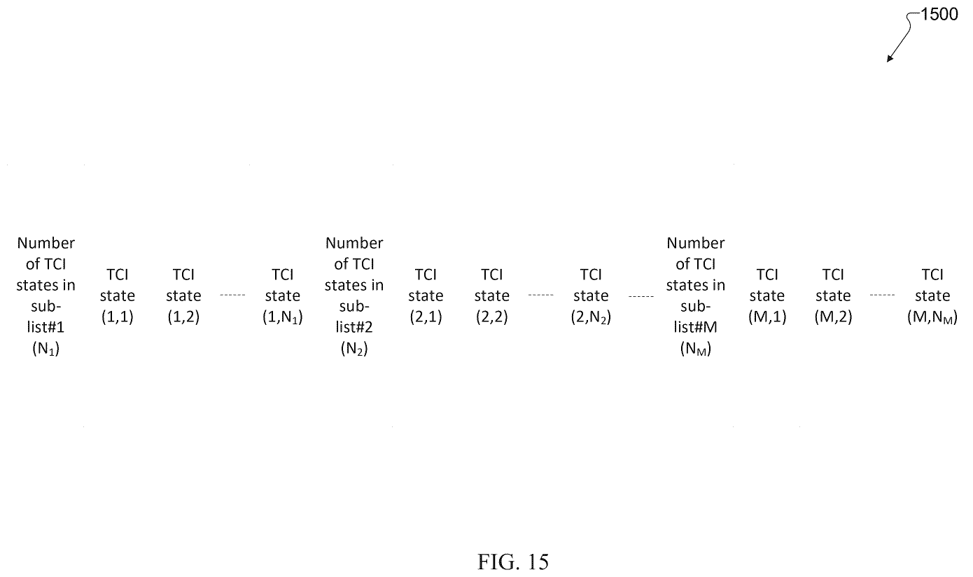

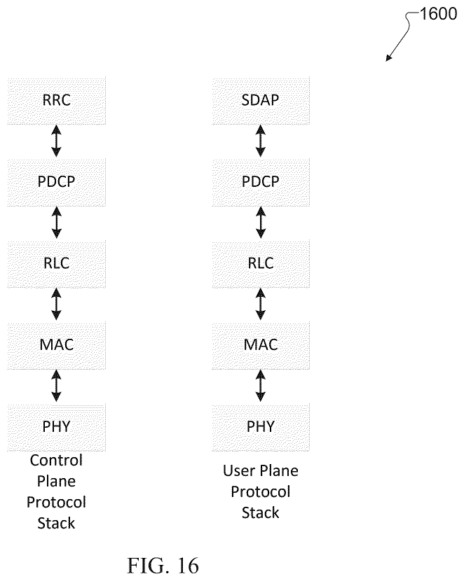

FIG. 15 illustrates examples of TCI states in sub-lists 1500 according to embodiments of the present disclosure. For example, TCI states in sub-lists 1500 can be grouped by any of the UEs 111-116 of FIG. 1, such as the UE 115. This example is for illustration only and other embodiments can be used without departing from the scope of the present disclosure.

In one example, the grouping of TCI states into sub-lists (or subsets) TCI states is performed by the UE and signaled to BS, e.g., the signaling is in an UL message:
In one example, the message or UL channel for signaling the grouping of TCI states into sub-lists (or subsets) of TCI states is also used for conveying the activation time of the sub-lists (or subsets) of the TCI states and the acknowledgment.
In one example, the message or UL channel for signaling the grouping of TCI states into sub-lists (or subsets) of TCI states is the also used for conveying the activation time of the sub-lists (or subsets) of the TCI states, but separate from the message or UL channel used to convey the acknowledgment.
In one example, the message or UL channel for signaling the grouping of TCI states into sub-lists (or subsets) of TCI states is also used for conveying the acknowledgment, but separate from the message or UL channel used to convey the activation time of the sub-lists (or subsets) of the TCI states.
In one example, the message or UL channel for signaling the grouping of TCI states into sub-lists (or subsets) of TCI states is separate from the message(s) or UL channel(s) used to convey the activation time of the sub-lists (or subsets) of the TCI states and/or the acknowledgment.
In one example, a separate messages or UL channels is used for (1) signaling the grouping of TCI states into sub-lists (or subsets) of TCI states, (2) signaling the activation time of the sub-lists (or subsets) of the TCI states, and (3) the acknowledgement.

In one example, the grouping of TCI states into sub-lists (or subsets) of TCI states is signaled as illustrated in FIG. 15. Each sub-list (or subset) TCI states is signaled using a number of TCI states in the sub-list (or subset) followed by a lists of activated TCI states. Additionally, the message can include the number of sub-lists (or subsets).

In one example, the grouping of TCI states into sub-lists (or subsets) of TCI states is signaled for each sub-list of TCI states as: a combinatorial index, e.g., a combinatorial index of the sub-list of TCI states from the list of activated TCI states or a combinatorial index of the sub-list of TCI states from the configured TCI states.

In one example, the grouping of TCI states into sub-lists (or subsets) of TCI states is signaled for each sub-list of TCI states as: (1) a number of TCI states in a sub-list of TCI states, and (2) a combinatorial index of the corresponding sub-list of TCI states either from the list of activated TCI states or from the configured TCI states.

In one example, a list of activation times signaled in an UL message, with an entry for activation time corresponding to a TCI state of the activated TCI states, or corresponding to a sub-list (or subset) of the activated TCI states.

The unified (main or indicated) TCI state is TCI state of UE-dedicated reception on PDSCH/PDCCH or dynamic-grant/configured-grant based PUSCH and dedicated PUCCH resources. In this disclosure, a TCI state can be referred to as a spatial resource unit.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that can be directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [[REF 4]-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g. format 0_1 or 0_2), wherein the DCI format includes a “transmission configuration indication” field that includes/indicates a TCI state code point out of the TCI state code points activated by a MAC CE. A DL related DCI format (or an UL related DCI format) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state code point can be indicated by a purpose designed channel or DCI Format. A TCI state (TCI state code point) indicated/included in a DL related DCI format or UL related DCI format or purpose designed channel or DCI Format is applied after a beam application time from the corresponding HARQ-ACK feedback in a PUCCH or a PUSCH transmission.

FIG. 16 illustrates an example RAN protocol stack 1600 according to embodiments of the present disclosure. For example, RAN protocol stack 1600 can be implemented by the BS 102 and the UE 116 of FIG. 1. This example is for illustration only and other embodiments can be used without departing from the scope of the present disclosure.

With reference to FIG. 16, an example of the protocol stack of NR networks is shown including physical (PHY) layer, medium access control (MAC) layer, radio link control (RLC) layer, packet data convergence protocol (PDCD) layer, for control plane there is radio resource control (RRC) layer, and for user plane there is service data adaptation protocol (SDAP) layer.

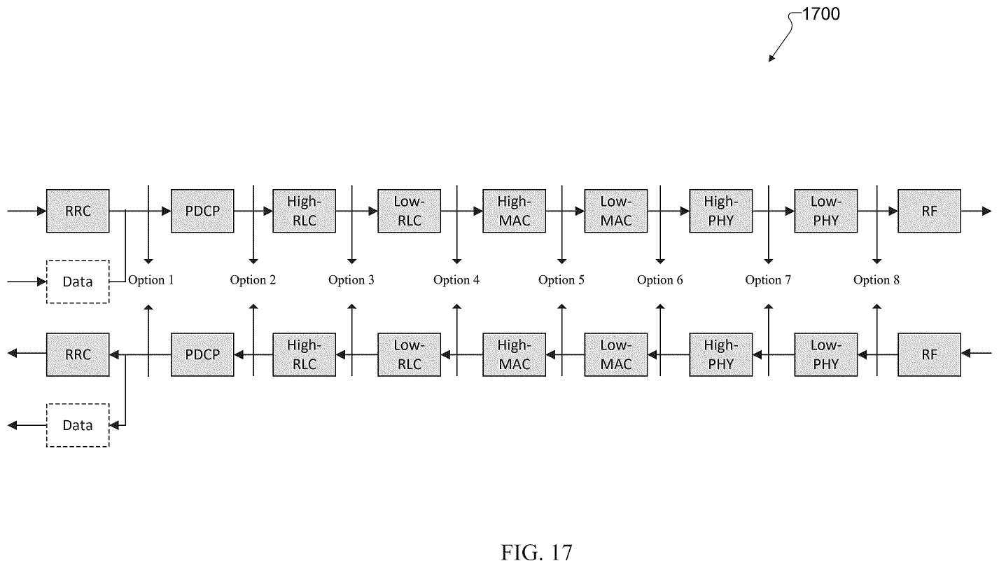

FIG. 17 illustrates example functional split points/options 1700 according to embodiments of the present disclosure. For example, functional split points/options 1700 may be implemented by the BS 102 of FIG. 2. This example is for illustration only and other embodiments can be used without departing from the scope of the present disclosure.

There can be different mappings of the layers of the protocol stack to actual devices implementing these functionalities. In one example, layers of the protocol stack can be mapped to a single device. In another example, the layers of the protocol stack can be split across multiple devices. 3GPP [TR 38.801] provides different functional split points between a central unit (CU) containing the higher layers of the protocol stack and a distributed unit (DU) containing the lower layers of the protocol stack. The functional split options provided by 3GPP are shown in FIG. 17 (TR 38.801—FIG. 21.1.1-1). For example, with functional split option 2, a CU contains the RRC and packet data convergence protocol (PDCP) layers, while a DU contains the RLC, MAC and PHY layers.

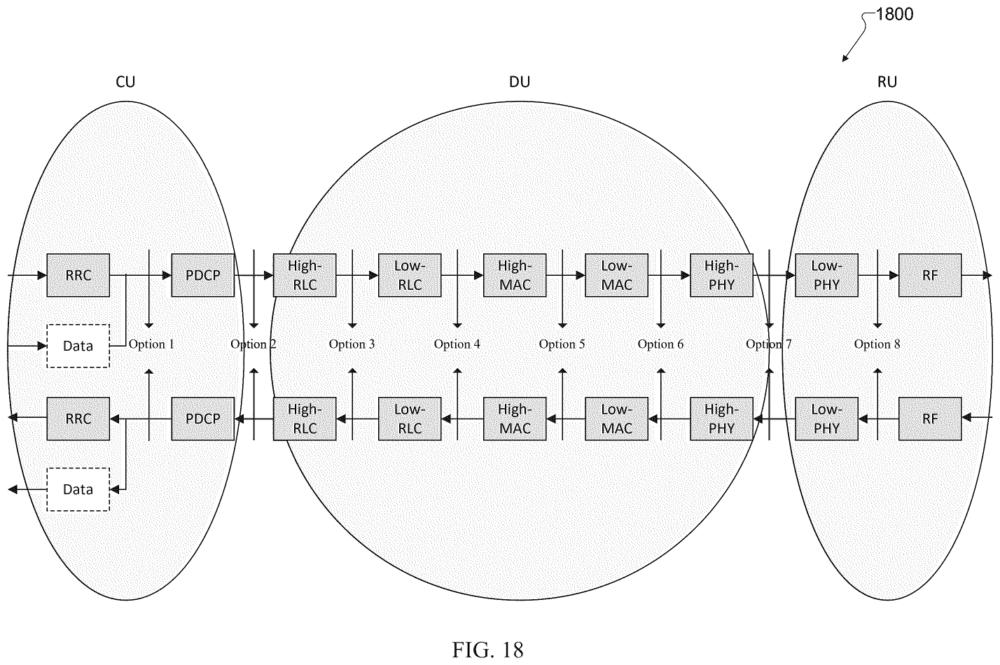

FIG. 18 illustrates example functional split points/options 1800 according to embodiments of the present disclosure. For example, functional split points/options 1800 may be implemented by the BS 103 of FIG. 1. This example is for illustration only and other embodiments can be used without departing from the scope of the present disclosure.

Multiple split options are also provided, for example, in addition to the higher layer split between the CU and DU (e.g., functional split option 2), there can be a split within the DU. For example, the DU can be split into DU and remote unit (RU). The O-RAN alliance has been considering a lower layer functional split, where the lower PHY and the RF reside in a remote unit (RU), while the higher PHY and layers above reside in the DU or CU. The lower level split being considered by the O-RAN alliance is similar to functional split option 7 of FIG. 17. There are various sub-options being provided for option 7 to define where the split occurs within the physical layer occurs. With reference to FIG. 18, an example protocol stack is shown with two functional split points, the first between the CU and the DU and the second between the DU and the RU.

In NR/5G, a geographical area served by the network (e.g., the network 130) can be partitioned into cells as mentioned herein. For example, a cell can be associated with a synchronization signal, physical broadcast channel (PBCH) block (SS/PBCH block). Within a cell, other common channels and/or signals can be transmitted to users in the cell. In another example, a cell is served by one or more TRPs or by one or more RUs.

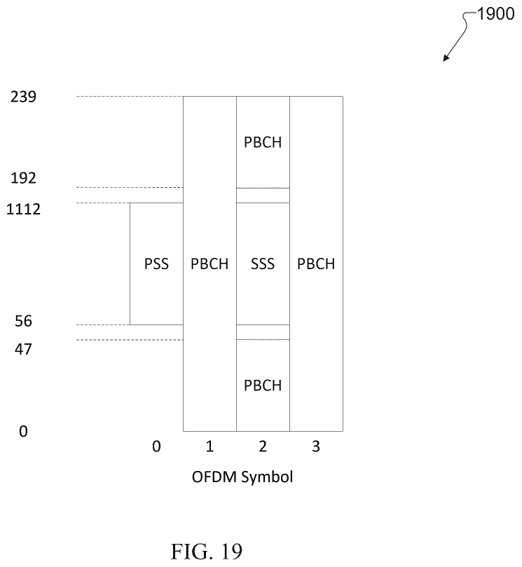

In NR/5G, a UE (e.g., the UE 116) performs the cell search procedure to acquire time and frequency synchronization within a cell and to detect the physical layer Cell ID (PCI) of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and including 4 consecutive symbols, and 20 resource blocks (RBs) (240 subcarriers), as illustrated in FIG. 19.

FIG. 19 illustrates an example SS/PBCH block 1900 according to embodiments of the present disclosure. For example, SS/PBCH block 1900 can be utilized by any of the UEs 111-116 of FIG. 1. This example is for illustration only and other embodiments can be used without departing from the scope of the present disclosure.

SSBs are organized in groups or bursts of up to N SSBs, transmitted within half a frame, each SSB within the group has an index i, where i=0, 1, . . . , N−1, within each group or burst of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon or in SSB-MTC-AdditionalPCI or in LTM-SSB-Config.

SSBs are transmitted periodically, where the allowed periodicities are {5, 10, 20, 40, 80, 160}ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH includes a preamble format comprising one or more preamble sequences transmitted in a PRACH Occasion (RO).

### NR Supports Four Different Preamble Sequence Lengths:

Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of RBs) and the resource allocated to an RO in the time domain (e.g., number of OFDMA symbols or number of slots), depend or the preamble sequence length, sub-carrier spacing of the preamble, sub-carrier spacing of the PUSCH in the UL BWP, and the preamble format. Multiple PRACH Occasions can be FDMed in one-time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of [REF 1]v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon or in SSB-MTC-AdditionalPCI or in LTM-SSB-Config are mapped to valid PRACH occasions in the following order [[REF 3]v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

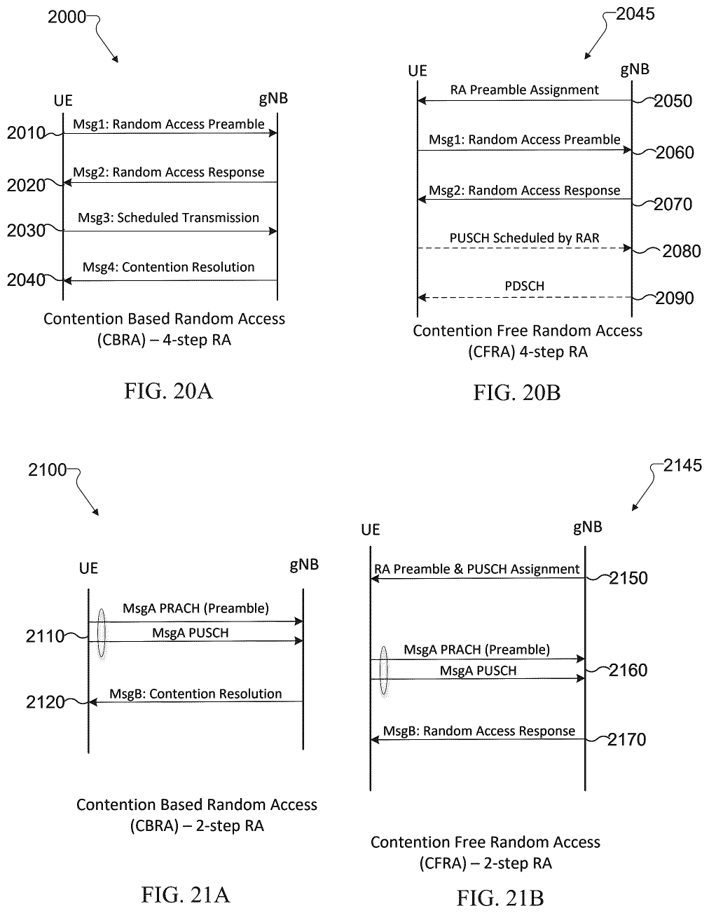

FIG. 20A illustrates a flowchart of an CBRA procedure 2000 according to embodiments of the present disclosure. For example, procedure 2000 can be performed by the UE 116 and the BS 102 and/or network 130 in the wireless network 100 of FIG. 1. This example is for illustration only and other embodiments can be used without departing from the scope of the present disclosure.

The procedure begins in 2010, a UE transmits a Msg1: random access preamble to a BS. In 2020, the BS transmits a Msg2: random access response to the UE. In 2030, the UE transmits a Msg3: scheduled transmission to the BS. In 2040, the BS transmits Msg4: contention resolution to the UE.

FIG. 20B illustrates a flowchart of an example CFRA procedure 2045 according to embodiments of the present disclosure. For example, CFRA procedure 2045 can be performed by the UE 116 and the BS 103 and/or network 130 in the wireless network 100 of FIG. 1. This example is for illustration only and other embodiments can be used without departing from the scope of the present disclosure.

The procedure begins in 2050, a BS transmits a RA preamble assignment to a UE. In 2060, the UE transmits a Msg1: random access preamble to the BS. In 2070, the BS transmits a Msg2: random access response to the UE. Then the UE may transmit PUSCH scheduled by RAR, to the BS (2080) and the BS may transmit PDSCH to the UE (2090).

FIG. 21A illustrates a flowchart of an example CBRA procedure 2100 according to embodiments of the present disclosure. For example, CBRA procedure 2100 can be performed by the UE 115 and the BS 102 and/or network 130 in the wireless network 100 of FIG. 1. This example is for illustration only and other embodiments can be used without departing from the scope of the present disclosure.

The procedure begins in 2110, a UE transmits MsgA PRACH (preamble) and MsgA PUSCH to a BS. In 2120, the BS transmits MsgB: contention resolution to the UE.

FIG. 21B illustrates a flowchart of an example CFRA procedure 2145 according to embodiments of the present disclosure. For example, CFRA procedure 2145 can be performed by the UE 115 and the BS 103 and/or network 130 in the wireless network 100 of FIG. 1. This example is for illustration only and other embodiments can be used without departing from the scope of the present disclosure.

The procedure begins in 2150, a BS transmits a RA preamble and PUSCH assignment to a UE. In 2160, the UE transmits MsgA PRACH (preamble) and MsgA PUSCH to the BS. In 2170, the BS transmits MsgB: random access response to the UE.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIG. 20;
In step 1, the UE transmits a random access preamble, also known as Msg1, to the BS. The BS attempts to receive and detect the preamble.
In step 2, the BS upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the BS upon receiving the RRC setup request message, allocates downlink and uplink resources that are transmitted in a downlink PDSCH transmission (RRC setup message) to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the BS indicates to the UE the preamble(s) to use.

Rel-16, introduced a new random access procedure; Type-2 random access procedure, also known as 2-step random access procedure (2-step RACH), is as illustrated in FIG. 21, that combines the preamble and PUSCH transmission into a single transmission from the UE to the BS, which is known as MsgA. Similarly, the RAR and the PDSCH transmission (e.g. Msg4) are combined into a single downlink transmission from the BS (e.g., the BS 102) to the UE, which is known as MsgB.

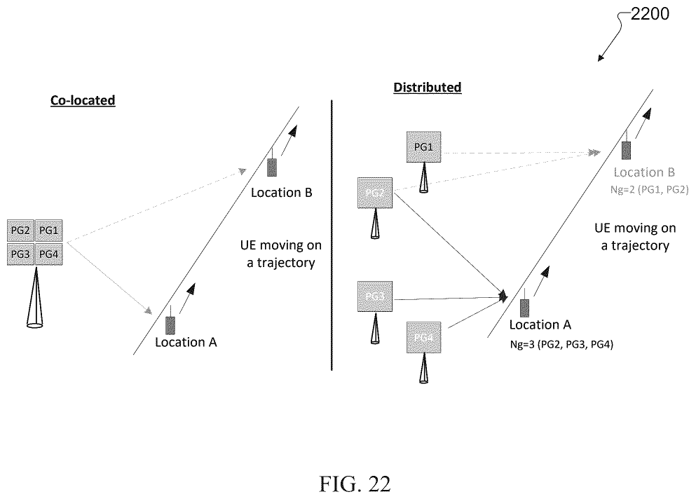

FIG. 22 illustrates examples of a UE moving on a trajectory 2200 located in co-located and distributed PGs according to embodiments of the present disclosure. For example, UE moving on a trajectory 2200 can be implemented by any of the UEs 111-116 of FIG. 1. This example is for illustration only and can be used without departing from the scope of the present disclosure.

In NR/5G, as a UE in RRC_CONNECTED mode moves around, the UE can connect to the network through different cells or different beams. There are two types of network controlled mobility procedures for UEs in RRC_CONNECTED mode: (1) Cell Level Mobility, also referred to as handover, that requires RRC signaling to be triggered and the UE changes its serving cell from a source serving cell to a target serving cell, and (2) Beam Level Mobility, that includes intra-cell beam level mobility and inter-cell beam level mobility and doesn't require explicit RRC signaling to be triggered. Alternatively, (2) can be PG-based mobility, as illustrated in FIG. 22. While the user moves from a location A to another location B, the set of PGs is updated from {PG2, PG3, PG4} to {PG1, PG2}. Consequently, a seamless beam-based (as opposed to cell-based) mobility is provided especially for RRC-connected UEs.

To improve handover procedures, 3GPP introduced several handover enhancements which include:
Dual Active Protocol Stack (DAPS): The source BS connection is maintained, i.e., a UE continues DL data reception from the source BS and UL data transmission to the source BS, after reception of the RRC message for handover, and until the source BS is released after successful random access to the target BS.
Conditional Handover (CHO): RRC configures handover parameters, however, the handover procedure is not executed by the UE until certain condition(s) are met at the UE. The UE evaluates the execution condition(s) upon receiving the CHO configuration, and stops evaluating the execution condition(s) once a handover is executed.
L1/L2 Triggered Mobility (LTM). The BS prepares and provides candidate cell(s) configuration(s) to the UE. The physical layer provides measurement reports that include reference signal received power (RSRP) of SS/PBCH blocks of candidate cell(s). Based on the measurement reports, the BS can change the serving cell to a target cell through a cell switch command signaled via MAC CE. The UE switches to the target cell following the cell switch command. The benefit of cell switch command is to reduce handover latency.

In NR Rel-18, CSI framework has been enhanced to support coherent joint transmission (CJT) across up 4 transmission reception points (TRPs) in FR1 (the 4 TRPs are referred to as a coordination set). The TRPs are expected to have ideal backhaul and synchronization, as well as the same the number of antenna ports across the TRPs. The Rel-16/17 Type-II and Type-II port selection codebooks have been enhanced for CJT.

This disclosure provides design aspects related to seamless mobility in FR1 with coherent joint transmission. As the user moves throughout the network, the coordination set can include TRPs in different cells, possibly the TRPs can have different number of antennas. The coordination set can be dynamically updated by dynamic signaling (e.g., L1 control DCI Format, or MAC CE).

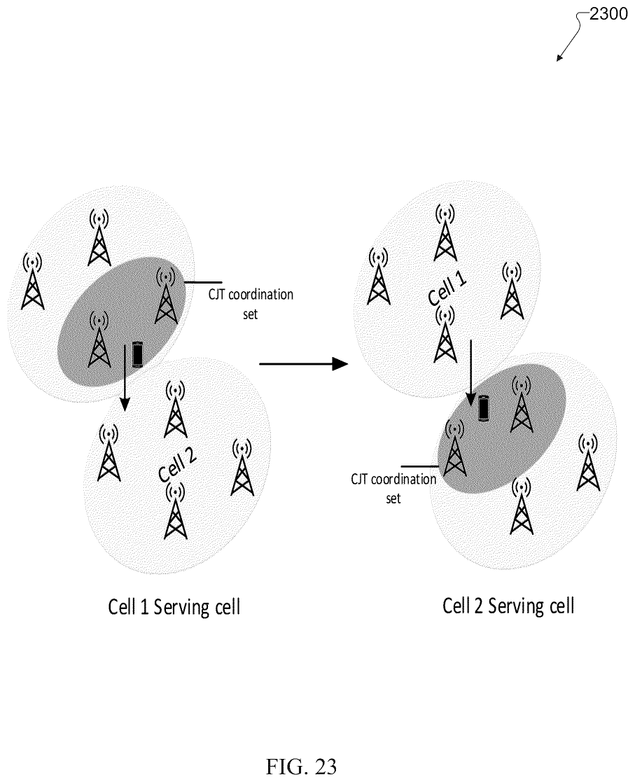

FIG. 23 illustrates examples of CJT coordination sets 2300 according to embodiments of the present disclosure. For example, CJT coordination sets 2300 can be implemented in the wireless network 100 of FIG. 1. This example is for illustration only and other embodiments can be used without departing from the scope of the present disclosure.

As mentioned herein, a geographical area served by a network is partitioned into cells. Cells can be mapped to or associated with RUs, DUs or CUs. A UE can connect to the network through one or more RUs associated with a serving cell. Or depending on propagation channel conditions, a UE can connect through RUs not associated with the serving cell. As a UE moves within the geographical area covered by the network, the cell or cells through which the UE connects to the network changes, and hence the RU(s) through which the UE connects to the network change. A UE can communication through multiple TRPs (CJT coordination set) using CJT. In NR, the TRPs belong to the same cell as shown in FIG. 23. Initially, the UE is in cell 1, the CJT coordination set includes TRPs from cell 1. As the UE moves to the cell edge, the signal strength from TRPs of adjacent cells (e.g., cell 2), can become strong enough to add to the coordination set. Without adding these TRPs, performance can degrade. Eventually, the UE moves to the coverage area of cell 2, and the UE establishes a link to the TRPs of cell 2 and drops the link to cell 1 as illustrated in FIG. 23. Embodiments of the present disclosure recognize that there are two potential issues with this type of operation, first the CJT coordination is limited to the TRPs of a cell, hence not benefiting from the CJT using the TRPs of an adjacent cell when close to it. The second, switch from a first set to a second set can involve higher layer switching which causes an interruption when the UE switches from cell 1 to cell 2. Not only does the interruption time lead to a reduction in throughput, but it can also lead to a higher link failure rate.

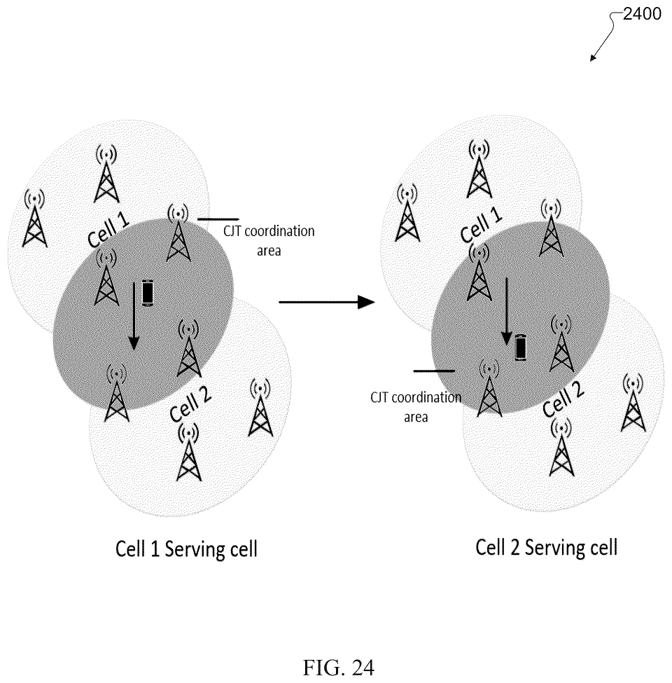

FIG. 24 illustrates examples of CJT coordination sets across TRPs 2400 according to embodiments of the present disclosure. For example, CJT coordination sets across TRPs 2400 can be implemented in the wireless network 100 of FIG. 1. This example is for illustration only and other embodiments can be used without departing from the scope of the present disclosure.

To address, this disclosure provides introducing a framework where CJT can be across TRPs in different cells as illustrated in FIG. 24. In FIG. 24, the CJT includes TRPs in two cells, cell 1 and cell 2. Initially, the serving cell of UE is cell 1, but the UE also communicates (using CJT) using TRPs in cell2. As the UE moves within the coverage area of cell 2, the serving cell can be updated to cell 2, which the UE continues to communicate to the network using TRPs from cell 1 and cell 2. Hence, the there is no interruption to the UE's traffic and the UE benefits from having a larger CJT coordination set that includes TRPs in cell 1 and cell 2.

The cell switch from cell 1 to cell 2 can happen using dynamic signaling (e.g., using L1 control DCI Format or using MAC CE). Furthermore, as the UE moves throughout the network, the CJT coordination set can be updated by dynamic signaling (e.g., using L1 control DCI Format or using MAC CE).

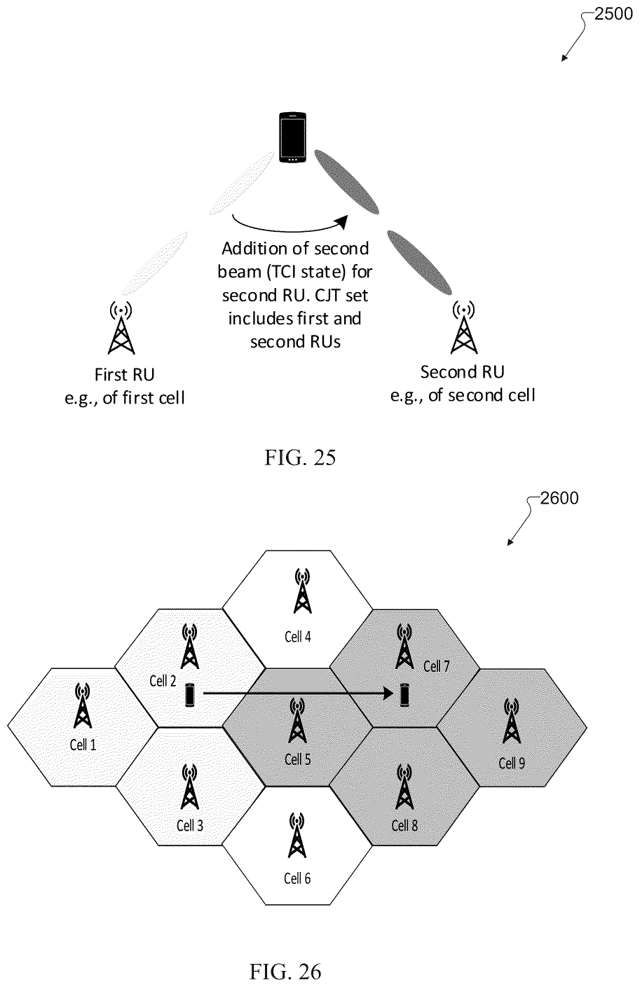

FIG. 25 illustrates an example system 2500 for UE switching/connecting to a different remote unit (RU) according to embodiments of the present disclosure. For example, system 2500 can be implemented in the wireless network 100 of FIG. 1. This example is for illustration only and other embodiments can be used without departing from the scope of the present disclosure.

For example, for dedicated channels or signals, a change in RU(s) can be signaled to the UE as a change in a quasi-co-location (QCL) or spatial domain filter (beam or port/PG) or TCI state, the UE communicates to the network through a first RU using a first QCL or spatial domain filter (beam or port/PG) or TCI state as illustrated in FIG. 25, if the UE is configured with CJT scheme for PDSCH (e.g., across different cells), and the UE indicates a capability to support two (or more) TCI states for CJT (e.g., across different cells), the UE can be indication a second QCL or spatial domain filter (beam or port/PG) or TCI state associated with a second RU on a second cell, the UE communicates to the network using CJT across the first and second RUs as illustrated in FIG. 25.

There are a few aspects to take into account here; first, how does the UE determine the spatial domain filters (beams or port/PGs) of the second RU, this includes configuration and activation of such beams or port/PGs or TCI states, also taking into account that the UE can be continuously moving hence new beams or port/PGs or TCI states are continuously being configured and activated for new RUs (or cells served by those RUs) the UE is moving closer to. Second, how does/is the UE signaled a change or addition in QCL or a spatial domain transmission filter (beam or port/PG) or TCI state from the first RU to the second RU, taking into account latency and overhead aspects. Third, as the UE moves to RUs associated with new cells, a serving cell change (or switch or handover) can take place, it is desirable to have such cell switch occur in a seamless way with minimum disruption to UE traffic and with high resilience and reliability. In one example, there is no cell switch command, but the UE switches from a first RU associated with a first cell to a second RU associated with a second cell by switching beams or TCI states, i.e., through a beam indication command (TCI state indication command) as included in FIG. 25. In one example, a UE can communicate with the network through multiple cells and RUs. For example, the UE can be indicated multiple beams (or TCI states) at the same time as mentioned herein, and uses the indicated beams (or TCI states) for reception and transmission.

FIG. 26 illustrates an example system 2600 for serving cells according to embodiments of the present disclosure. For example, system 2600 can be implemented in the wireless network 100 of FIG. 1. This example is for illustration only and other embodiments can be used without departing from the scope of the present disclosure.

As the UE moves throughout the geographical area served by the network, the TRP(s) or RU(s) through which the UE communicates changes, based on the UE's location within the geographical area as illustrated in FIG. 26. In FIG. 26, as an example, a UE moves from cell 2, where the UE communicates through the TRP(s) or RU(s) of cell 2, to cell 5 where the UE first communicates through the TRPs or RUs of cell 2 and cell 5 (CJT across cell 2 and cell 5), and then through the TRP(s) or RU(s) of cell 5 as the UE moves further away from cell 2. In one example, there is no cell change or switch when the UE communicates through the TRP(s) or RU(s) of cell 5, a beam (or TCI state) indication to the UE is used to indicate a beam(s) (or TCI state(s)) associated with the TRP(s) or RU(s) of cell 5 through which the UE communicates. In one example, after a beam change to cell 5, higher layer procedures can trigger a handover or cell switch from cell 2 to cell 5. The UE continues to move to cell 7, where the UE first communicates through the TRPs or RUs of cell 5 and cell 7 (CJT across cell 5 and cell 7), then the UE communicates through the TRP(s) or RU(s) of cell 7 as the UE moves further away from cell 5. In one example, there is no cell change or switch when the UE communicates through the TRP(s) or RU(s) of cell 7, a beam (or TCI state) indication to the UE is used to indicate a beam(s) or TCI state(s) associated with the TRP(s) or RU(s) of cell 7 through which the UE communicates. In one example, after a beam change to cell 7, higher layer procedures can trigger a handover or cell switch from cell 5 to cell 7.

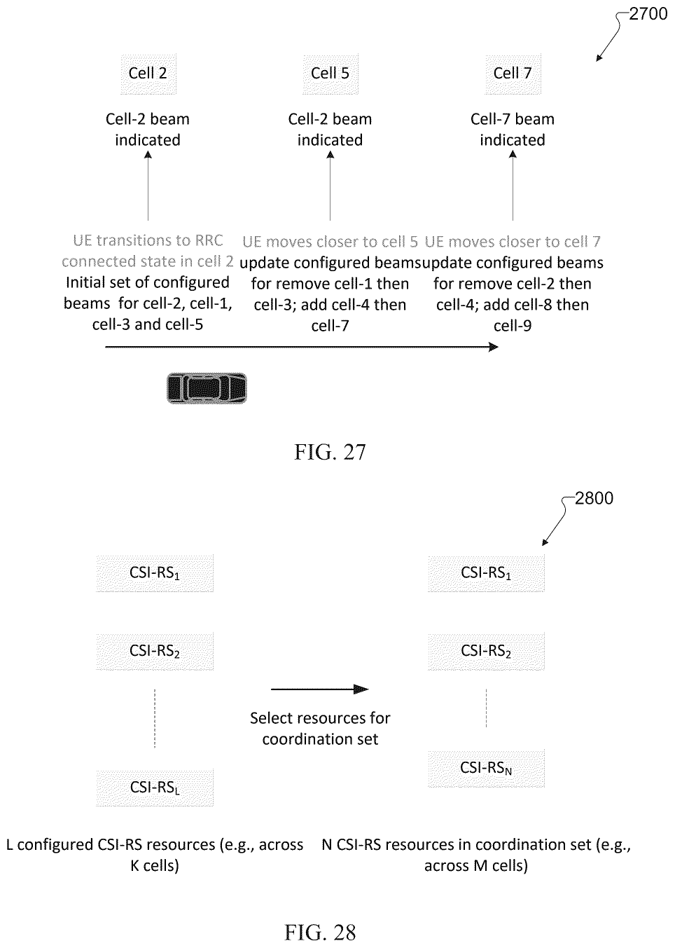

FIG. 27 illustrates an example of UE mobility 2700 according to embodiments of the present disclosure. For example, ULE mobility 2700 can be implemented in the wireless network 100 of FIG. 1. This example is for illustration only and other embodiments can be used without departing from the scope of the present disclosure.

With reference to FIG. 27, one example of mobility for the UE of FIG. 26 is shown. The UE transitions to the connected mode in cell 2. The UE can be configured with beams or TCI states associated with the cells in the neighborhood of the UE. For example, these can be beams or TCI states associated with cell-1, cell-3 and cell-5 in addition to cell-2. A configuration with a beam or TCI state is used, for example, to mean one or more of the following:
Configuration with a reference signal (e.g., CSI-RS or SSB) used for beam measurement, wherein the reference signal is associated with a spatial domain filter corresponding to a beam.
Configuration with a reference signal (e.g., CSI-RS or SSB) used for beam or TCI state indication, wherein the reference signal is associated with a QCL or spatial domain filter corresponding to a beam or TCI state.
Configuration with a TCI state or spatial relation information used for beam indication, wherein the TCI state or spatial relation information can include a reference signal for (1) quasi-co-location (QCL) (e.g., QCL Type A or Type B or Type C or Type D), or (2) spatial relation information/beam indication, and the reference signal is associated with a spatial domain filter or QCL type corresponding to a beam.

The UE can provide measurement reports for the configured beams or TCI states (e.g., measurement reference signals). Based on measurements/measurement reports, the network (e.g., BS), and/or the UE can activate a subset of beams (e.g., reference signals or TCI states as mentioned herein). Furthermore, based on the measurements/measurement reports, the network (e.g., BS), and/or the UE can indicate and/or activate one or more beams (e.g., reference signals or TCI states as mentioned herein). As the UE (e.g., the ULE 116) moves, the configured beams can be updated. For example, as the UE moves closer to cell 5 and into cell 5, configured beams can be added for cell 4 and cell 7, and configured beams can be removed for cell 1 and cell 3. Based on the updated configuration of beams and measurement reports, beams are activated or deactivated and new beams can be indicated to UE through which the UE communicates with the network. For example, as the UE moves closer to cell 5, the indicated beam (e.g., TCI state or reference signal) can be associated with cell 5. In a variant example, a UE can be simultaneously indicated two beams or TCI states for cell 2 and cell 5, e.g., using CJT across cells 2 and 5. As the UE moves closer to cell 7 and into cell 7, configured beams can be added for cell 8 and cell 9, and configured beams can be removed for cell 2 and cell 4. Based on the updated configuration of beams or TCI states and measurement reports, beams or TCI states are activated or deactivated and new beams or TCI states can be indicated to UE through which the UE communicates with the network. For example, as the UE moves closer to cell 7, the indicated beam (e.g., TCI state or reference signal) can be associated with cell 7. In a variant example, a UE can be simultaneously indicated two beams or TCI states for cell 5 and cell 7, e.g., using CJT across cells 5 and 7. In this example, the UE changes the cell(s) (or TRP(s) or RU(s)) through which it communicates to the network based on beam (e.g., reference signal) measurement and reporting and beam (e.g., TCI state) indication (e.g., beam-based mobility).

In the example of FIG. 27, the configuration (e.g., initial configuration and/or addition and/or removal) of beams (e.g., measurement reference signals, or beam indication reference signals or TCI states or spatial resource units), can be following the examples of this disclosure based on (1) UE-dedicated or UE-specific signaling (e.g., RRC signaling or MAC CE signaling or L1 control signaling), or (2) UE-common (e.g., to a group of UEs or UEs in a cell or associated with an entity), using e.g., SIB signaling (e.g., common channels from the cell the UE is communicating with the network through or a neighbor cell), or RRC signaling or MAC CE signaling or L1 control signaling.

In one example, the reference signal for beam or TCI state indication when the UE is in connected mode (e.g., when the UE is within a cell or when the UE is moving between cells (mobility)) can be separate (e.g., has separate configuration) from the reference signal for initial beam acquisition, e.g., when the UE is transitioning to the connected mode.

In one example, the reference signal for beam or TCI state indication when the UE is in connected mode (e.g., when the UE is within a cell or when the UE is moving between cells (mobility)) can be from the same configuration as the reference signal for initial beam acquisition, e.g., when the UE is transitioning to the connected mode.

In NR, there are different levels of abstraction for beam or TCI state indication and antenna port indication, which adds unnecessary complexity to MIMO and beam indication. To simplify beam and/or antenna port indication, a spatial resource unit is regarded as the basic unit, wherein the spatial resource unit, is a one-port channel, with one-input and one-output. “An antenna port is defined such that the channel over which a symbol on the antenna port is conveyed can be inferred from the channel over which another symbol on the same antenna port is conveyed” [REF 1]. A UE can be indicated with one or more spatial resource units. In the case of seamless mobility, the spatial resource units can belong to different cells, e.g., for CJT.

For application of a spatial resource unit, the spatial resource unit can be first activated, and then indicated. The activation of a spatial resource unit, allows the UE time to measure the spatial resource unit and be ready to use it when it is indicated. The indication of the spatial resource unit is when the UE is signaled to use (e.g., for transmission or reception) the spatial resource unit. A UE can be configured multiple spatial resource units, in different cells. As the UE moves through the network (e.g., the network 130), the configured spatial resource units can be updated as UE moves away from some cells and towards other cells. The multiple spatial resource units can be in a same set, or in different sets, for example one set for DL and/or joint spatial resource units and one set for UL spatial resource units. The UE can then be activated one or more of the spatial resource units. The spatial resource units can be activated in a single set or in multiple sets. The UE can then be indicated one or more spatial resource units from the activated spatial resource units. In a variant example, there is no activation of spatial resource units, the configured spatial resource units can be directly indicated. Indicated spatial resource units are used for reception or transmission at the UE or BS.

In this disclosure a spatial resource unit is defined as a reference signal (e.g., a reference signal with one antenna port) or an antenna port of a reference signal of a cell or RU. A spatial resource unit is identified by an ID (e.g., spatial resource unit ID). In one example, one set of spatial resource units is configured or re-configured across multiple cells or RUs. In another example, different sets of spatial resource units are configured or re-configured for different cells or RUs, the spatial resource unit can contain an ID of a cell or RU, and an ID of spatial resource unit within the set of spatial resource units configured for the cell or RU. A spatial resource unit can be referred to as a TCI state, hence, a spatial resource unit ID can be referred to as a TCI state ID. A spatial resource unit can be referred to as an antenna port (or a port), hence, a spatial resource unit ID can be referred to as an antenna port ID or port ID. A spatial resource unit can be referred to as a reference signal, hence, a spatial resource unit ID can be referred to as a reference signal ID.

In this disclosure configuration and signaling for support of coherent joint transmission (CJT) using TRPs than can span more than one cell (CJT coordination set) is provided. Methods to update the CJT coordination set using dynamic signaling (e.g., L1 control DCI Format or MAC CE) are also provided.

The present disclosure relates to a NR/5G and/or 6G communication system.

This disclosure provides aspects related to coherent joint transmission (CJT) mobility in a network for user in connected mode, to reduce latency and overhead of signaling associated with mobility, reduce disruption time due to mobility and improve reliability and resilience. The following aspects are provided:
Configuration of reference signals for CJT across multiple cells.
Configuration of multiple sets of reference signals for CJT, wherein a set can correspond to a reference signals of cell.
Configuration of spatial resource units (e.g., reference signals or antenna ports or TCI states) for seamless mobility across multiple cells or RUs.
Signaling aspects for updating CJT coordination set.

In the following, both FDD and TDD are regarded as a duplex method for DL and UL signaling. In addition, full duplex (XDD) operation is provided, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE and can be UE common (e.g., to a group of UEs). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format in DL or UCI in UL) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or BS) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or BS) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/BS (e.g., the network 130/the BS 102) receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/BS receives the source RS, the NW/BS can measure and calculate the needed information to assign a particular DL (or/and UL) TX beam to the UE, for example in case of channel reciprocity.

In one example, when selecting K elements from set S1 with N elements, there are

$$( \begin{matrix}N \\ K\end{matrix} )$$

possible choices. A unique combinatorial index can be found for subset S2 {a₀, a₁, . . . , a_{K-1}}, where aₖ for k=0, 1, . . . , K−1, corresponds to an element of set S1 (e.g., an index of an element in set S1 in the range 0, 1, . . . , N−1). If a₀, a₁, . . . , a_{K-1} are arrange in subset S2 such that a₀>a₁> . . . >a_{K2-1}, the index of subset S2 is given by:

$${\sum }_{k = 0}^{K - 1} < \begin{matrix}{a}_{k} \\ K - k\end{matrix} > , where < \begin{matrix}x \\ y\end{matrix} >= \{ \begin{matrix}( \begin{matrix}x \\ y\end{matrix} ) & x \geq y \\ 0 & otherwise\end{matrix}$$

$$( \begin{matrix}x \\ y\end{matrix} ) = \frac{x !}{( x - y ) ! y !}$$

In one example, the device selecting K elements out of N elements, can indicate the number K and a combinatorial index for the selection of K out N elements. In one example, K can be determined by configuration and the device selecting K elements out of N elements indicates the combinatorial index for the selection of K out N elements.

In this disclosure, a spatial resource unit or beam or PG management reference signal refers to a reference signal, a UE can use for beam or PG management procedure. A beam or PG management procedure can include:
Initial beam or PG acquisition for identifying a spatial filter or a beam or a beam pair (or port/PG pair) between two devices (e.g., UE and BS/TRP or between two UEs) during channel setup. This includes initial beam (port) sweeping (within a PG) to identify a beam (or port) pair between the two devices. This can also include identifying a beam or a beam pair (or port/PG pair) between a UE and new BS/TRP in case of handover.
Spatial filter or beam or PG maintenance for refining and tracking the beam or PG as the UE moves around or the channel conditions change. This includes spatial filter or beam or PG measurement and reporting, and spatial resource unit or beam or port/PG indication signaling.
Spatial filter or beam or PG failure detection and recovery, an emergency-only procedure for determining when a beam has failed, and identifying a new beam to use instead. Beam failure events are typically rare and, in the unlikely event that a beam fails, beam recovery should be reliable and fast and before the link fails.

In one example, spatial resource unit beam or PG management reference signals, also referred to as reference signals in this document can include:
A SS/PBCH block, which includes one or more synchronization signals carrying a cell ID (or a BS/TRP ID or a RU ID), and a channel carrying minimum system information or part of the minimum system information, wherein the minimum system information is the information required by the UE to access the network. In one example, the SS/PBCH block is not associated with PCI. In one example, the SS/PBCH is associated with PCI. In one example, the SS/PBCH block is a non-cell defining (NCD) SS/PBCH block. In one example, the SS/PBCH block is a cell defining (CD) SS/PBCH block.
low-power synchronization signal (LP-SS) or synchronization signal (SS) (e.g., PSS and/or SSS). In one example, LP-SS or SS which includes one or more synchronization signals carrying a cell ID (or a BS/TRP ID or a RU ID). In one example, LP-SS is based on on-off keying modulation. In one example, LP-SS is received or transmitted on a low power radio separate from the main radio. In one example, the LP-SS or SS is not associated with PCI. In one example, the LP-SS is associated with PCI.
Channel state information reference signal (CSI-RS). In one example, the CSI-RS is not associated with a PCI. In one example, the CSI-RS is associated with PCI. In one example, the CSI-RS is QCLed with another CSI-RS. In one example, the CSI-RS is associated with PCI. In one example, the CSI-RS is QCLed with SS/PBCH block. In one example, the CSI-RS is QCLed with LP-SS or SS. In one example, the CSI-RS has no source RS, e.g., the CSI-RS is the root of the QCL relation. In one example, the CSI-RS has one antenna port. In one example, the CSI-RS has more than one antenna port.

FIG. 28 illustrates examples of reference signal configurations 2800 according to embodiments of the present disclosure. For example, any of the UEs 111-116 of FIG. 1 may be configured by reference signal configurations 2800. This example is for illustration only and other embodiments can be used without departing from the scope of the present disclosure.

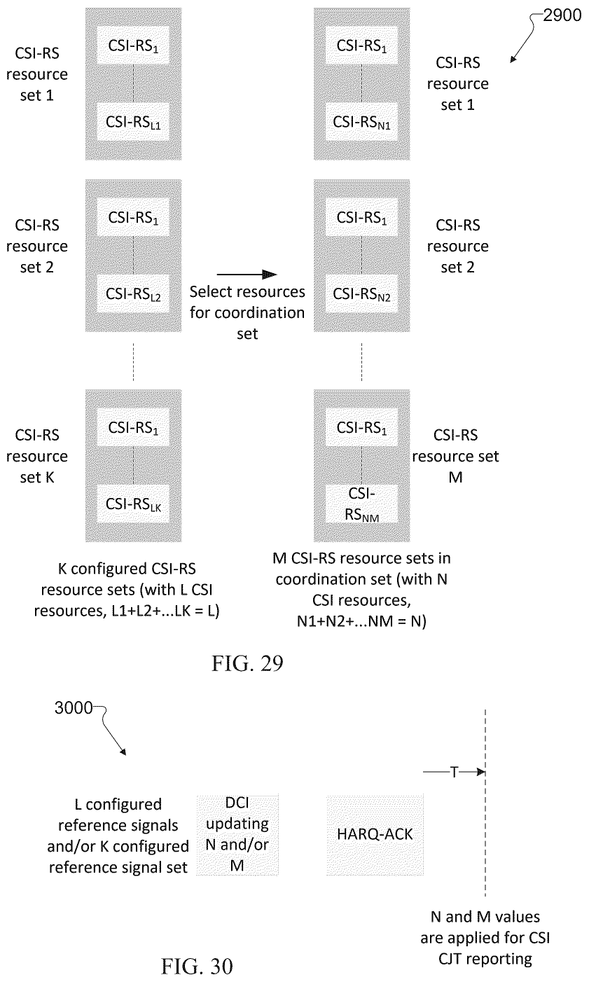

FIG. 29 illustrates examples of reference signal set configurations 2900 according to embodiments of the present disclosure. For example, any of the UEs 111-116 of FIG. 1 may be configured by reference signal set configurations 2900. This example is for illustration only and other embodiments can be used without departing from the scope of the present disclosure.

In one example, the UE is configured reference signals across multiple cells. In one example, the reference signal is a channel state information reference signal. In one example, a reference signal associated with a first cell has a QCL source as an SS/PBCH block or LP-SS or SS associated with a first PCI, a reference signal associated with a second cell has a QCL source as an SS/PBCH block or LP-SS or SS associated with a second PCI, . . . , a reference signal associated with a Kth cell has a QCL source as an SS/PBCH block or LP-SS or SS associated with a Kth PCI.

In one example, a reference signal associated with a first cell has or is configured a first sub-carrier spacing (SCS) and/or a first absolute radio-frequency channel number (ARFCN) value and/or a first cyclic prefix (CP), a reference signal associated with a second cell has or is configured a second SCS and/or a second ARFCN value and/or a second CP, . . . , a reference signal associated with a Kth cell has or is configured a Kth SCS and/or a Kth ARFCN value and/or a Kth CP.

In one example, a reference signal association with a first cell is in a first reference signal set, a reference signal association with a second cell is in a second reference signal set, . . . , a reference signal association with a Kth cell is in a Kth reference signal set.

In one example, a reference signal set associated with a first cell has or is configured a first SCS and/or a first ARFCN value and/or a first CP, a reference signal set associated with a second cell has or is configured a second SCS and/or a second ARFCN value and/or a second CP, . . . , a reference signal set associated with a Kth cell has or is configured a Kth SCS and/or a Kth ARFCN value and/or a Kth CP.

In one example, the UE (e.g., the UE 116) can be configured with L reference signals (e.g., L CSI-RS), wherein the L reference signals are in K cells as illustrated in FIG. 28. In one example, the UE can be configured with K reference signal sets (e.g., K CSI-RS resource sets) as illustrated in FIG. 29. In one example, the first reference signal set includes L₁ reference signals, the second reference signal set includes L₂ reference signals, . . . , the Kth reference signal set includes L_{K} reference signals. In one example, K≤L. In one example,

$$L = {\sum }_{k = 0}^{K} {L}_{k} .$$

In one example as the UE moves in the network, the L reference signals are updated based on the UEs locations in the network. In one example as the UE moves in the network, the K reference signal sets are updated based on the UEs locations in the network.

In one example, the value (e.g., maximum value) of L depends on a UE capability. In one example, the value (e.g., maximum value) of K depends on a UE capability.

In one example, a CJT coordination set includes multiple TRPs (e.g., N TRPs). In one example, the multiple TRPs (e.g., N TRPs) belong to a same cell. In one example, the multiple TRPs (e.g., N TRPs) belong to different cells. In one example, the CJT coordination set includes N reference signal resources (e.g., N CSI-RS resources), wherein a first reference signal is associated with a first TRP, a second reference signal is associated with a second TRP, . . . a Nth reference signal is associated with an Nth TRP. In one example, the N TRPs or the N reference signal resources belong to or are associated with M cells, wherein, M≤N, e.g., multiple TRPs or reference signals (e.g., CSI-RS) are associated with a same cell. In the aforementioned, a TRP can be replaced by an RU.

In one example, the CJT coordination set includes M reference signal resource sets (e.g., M CSI-RS resource sets). In one example, a first reference signal set is associated with a first cell, a second reference signal set is associated with a second cell, . . . , a Mth reference signal set is associated with a Mth cell. In one example, the M resource sets (e.g., M CSI-RS resource sets) include N reference signals (e.g., N CSI-RS), wherein, M≤N, a CSI-RS resource can be associated with a TRP. In one example, the number of reference signals in a first resource set is N₁, the number of reference signals in a second resource set is N₂, . . . the number of reference signals in a Mth resource set is N_{M}, wherein

$$N = {\sum }_{n = 0}^{N} {N}_{m} .$$

In one example, the antenna configuration (e.g., number of ports or N₁, N₂, O₁, O₂) can be the same across the N reference signals (e.g., N CSI-RS) resources. In one example, the antenna configuration (e.g., number of ports or N₁ₘ, N₂ₘ, O₁ₘ, O₂ₘ) can be the same across the Nₘ reference signals (e.g., Nₘ CSI-RS) resources in reference signal set (e.g., CSI-RS resource set) m, where m=1, 2, . . . , M.

In one example, the value (e.g., maximum value) of N depends on a UE capability. In one example, the value (e.g., maximum value) of M depends on a UE capability.

In one example, as the UE moves around the UE can be signaled by dynamic signaling, the set of N reference signals in the coordination set out of the L configured reference signals as illustrated in FIG. 28. In one example, the signaling can be by L1 control (e.g., DCI Format signaling). In one example, the signaling can be by MAC CE signaling. In one example, the signaling can be RRC signaling.

In one example, the signaling can be by bitmap, e.g., a bitmap of size L, wherein a bit in the bitmap corresponds to one of the configure L reference signals. In one example, if the bit in the bitmap is 1, the corresponding reference signal is included in the coordination set, and if a bit in the bitmap is 0, the corresponding reference signal is not included in the coordination set. In one example, if the bit in the bitmap is 0, the corresponding reference signal is included in the coordination set, and if a bit in the bitmap is 1, the corresponding reference signal is not included in the coordination set.

In one example, the signaling can be by a combinatorial index, e.g., the signaling can indicate a number N, and a corresponding combinatorial index for selecting N out of L elements. In one example, the signaling is a two stage signaling, wherein the first stage includes the number N and the second stage include the combinatorial index. The size of the combinatorial index can depend on the number N.

In one example, as the UE moves around the UE can be signaled by dynamic signaling, M reference signals sets in the coordination set out of the K configured reference signal sets as illustrated in FIG. 29. In one example, for the M reference signal sets, the UE can be signaled N₁, N₂, . . . , N_{M} reference signals for each set respectively. In one example, the signaling can be by L1 control (e.g., DCI Format) signaling. In one example, the signaling can be by MAC CE signaling. In one example, the signaling can be RRC signaling.

In one example, the signaling can be by bitmap across L reference signals, wherein the reference signals are arranged across reference signal sets, e.g., a bitmap of size

$$L = {\sum }_{k = 0}^{K} {L}_{k} ,$$

wherein a bit in the bitmap corresponds to one of the configure L reference signals in the K reference signal sets. In one example, the bits are arrange from the most significant bit (MSB) (or least significant bit (LSB)), first L₁ bits for first reference signal set, then L₂ bits for second reference signal, . . . then L_{K} bits for Kth reference signal. In one example, if the bit in the bitmap is 1, the corresponding reference signal is included in the coordination set, and if a bit in the bitmap is 0, the corresponding reference signal is not included in the coordination set. In one example, if the bit in the bitmap is 0, the corresponding reference signal is included in the coordination set, and if a bit in the bitmap is 1, the corresponding reference signal is not included in the coordination set.

In one example, the signaling can be by two level bitmap, wherein the first level can indicate M of the K reference signal sets in the coordination set, the second level can be bitmap for each the M reference signal sets indicating Nₘ reference signals of the corresponding Lₖ₍ₘ₎ reference signals for configured reference signal set k(m), where k(m) is the mth reference signal set in the coordination set.

In one example, the signaling can be by combinatorial index across L reference signals, wherein the reference signals are arranged across reference signal sets, e.g.,

$$L = {\sum }_{k = 0}^{K} {L}_{k}$$

reference signals arranges across reference signal set, e.g., starting from the first or last reference signal set. In one example, the signaling is a two stage signaling, wherein the first stage includes the number N and the second stage includes the combinatorial index. The size of the combinatorial index can depend on the number N as aforementioned.

In one example, the signaling can be by two level combinatorial index, wherein the first level can be a combinatorial index indicating M of the K reference signal sets in the coordination set, the second level can be a combinatorial index for each the M reference signal sets indicating Nₘ reference signals of the corresponding Lₖ₍ₘ₎ reference signals for configured reference signal set k(m), where k(m) is the mth reference signal set in the coordination set.

In one example, the signaling can be by two levels a first level is a bitmap and a second level is a combinatorial index, and a wherein the first level can be a bitmap indicating M of the K reference signal sets in the coordination set, the second level can be a combinatorial index for each the M reference signal sets indicating Nₘ reference signals of the corresponding Lₖ₍ₘ₎ reference signals for configured reference signal set k(m), where k(m) is the mth reference signal set in the coordination set.

In one example, the signaling can be by two levels a first level is a combinatorial index and a second level is a bitmap, and a wherein the first level can be a combinatorial index indicating M of the K reference signal sets in the coordination set, the second level can be a bitmap for each the M reference signal sets indicating Nₘ reference signals of the corresponding Lₖ₍ₘ₎ reference signals for configured reference signal set k(m), where k(m) is the mth reference signal set in the coordination set.

FIG. 30 illustrates a timeline 3000 for CSI CJT reporting according to embodiments of the present disclosure. For example, timeline 3000 can be followed by the ULE 116 and the BS 102 and/or network 130 in the wireless network 100 of FIG. 1. This example is for illustration only and other embodiments can be used without departing from the scope of the present disclosure.

In one example with L reference signals configured and/or K reference signal sets configured, UE is indicated a coordination set of N reference signals and/or M reference signal sets. In one example, the indication by L1 control (e.g., DCI Format signaling) as illustrated in FIG. 30. In one example, the indication by MAC CE. In one example, the indication can be RRC signaling. In one example, in response to the indication the UE can send a HARQ-ACK. In one example, the indicated values for N and/or M can be applied after a time T from the start or the end of the downlink signal (e.g., DCI or MAC or RRC) carrying the values of N and/or M. In one example, the indicated values for N and/or M can be applied after a time T from the start or the end of the signaling carrying the HARQ-ACK (e.g., positive HARQ-ACK) acknowledging the DL signal carrying the values of N and/or M as illustrate FIG. 30. In one example, the indicated values are applied at the start of the first slot or time-unit after time T from the start or end of the DL signal or the signal with the corresponding HARQ. In one example, the SCS of slot and/or time-unit can be the smallest SCS of DL signal and/or the signal of the HARQ-ACK and/or the L configured reference signals and/or the N reference signals in the coordination set.

In variant of the example herein, the UE is configured with L reference signals and/or K reference signal sets. A UE is configured a mapping or association between the indicated TCI state(s) and a subset Lₛ of the L reference signals and subset Kₛ of the K reference signal sets. In a variant example, Lₛ and Kₛ can be indicated or activated or configured to the UE. In one example, the selection of N reference signals and/or M reference signal sets is from the Lₛ and Kₛ respectively, using a bitmap or combinatorial index as afore mentioned.

In one example, the value (e.g., maximum value) of Lₛ depends on a UE capability. In one example, the value (e.g., maximum value) of Kₛ depends on a UE capability.

In one example, the UE is configured with L reference signals across K reference signal sets (e.g., corresponding to cells). In one example, a reference signal has Pₗ ports, wherein l=1, 2, . . . L. In one example, Pₗ is the same value for L reference signals. In one example, Pₗ is the same value for reference signal in a reference signal set (or a cell).

In one example, a UE is indicated Nₗ reference signals in Mₗ reference signal sets for quasi-co-location with corresponding DM-RS ports. In one example, the indication can by bitmap or by combinatorial index as mentioned herein. In one example, the QCL is with respect to Type-A QCL. In one example, the QCL is with respect to type-A QCL except for QCL parameters {Q1, Q2, . . . } for a subset of the N₁ reference signals and/or a subset of the Mₗ reference signal sets. Wherein, Q1, Q2, . . . is a subset of one or more of: Doppler spread, Doppler shift, average delay and delay spread.

In one example, a UE is indicated P antennas ports in Nₗ reference signals in Mₗ reference signal sets for quasi-co-location with corresponding DM-RS ports. In one example, the indication can by bitmap or by combinatorial index. In one example, the QCL is with respect to Type-A QCL. In one example, the QCL is with respect to type-A QCL except for QCL parameters {Q1, Q2, . . . } for a subset of the P ports and/or Nₗ reference signals and/or a subset of the Mₗ reference signal sets. Wherein, Q1, Q2, . . . is a subset of one or more of. Doppler spread, Doppler shift, average delay and delay spread.

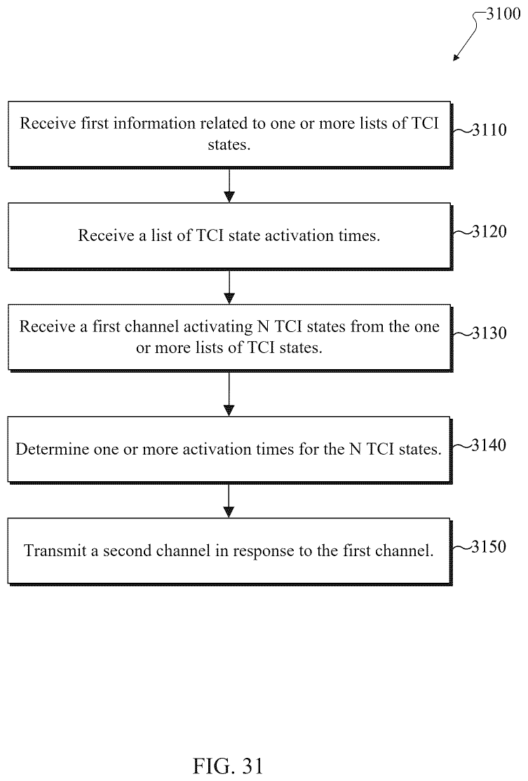

FIG. 31 illustrates an example method 3100 performed by a UE in a wireless communication system according to embodiments of the present disclosure. The method 3100 of FIG. 31 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3100 is for illustration only and other embodiments can be used without departing from the scope of the present disclosure.

The method 3100 begins with the UE receiving first information related to one or more lists of TCI states (3110). The UE then receives a list of TCI state activation times (3120). The UE then receives a first channel activating N TCI states from the one or more lists of TCI states (3130).

The UE then determines one or more activation times for the N TCI states (3140). The UE then transmits a second channel in response to the first channel (3150). For example, in 3150, the second channel signals the one or more activation times for the N TCI states.

In various embodiments, the one or more activation times for the N TCI states is T slots. The second channel is transmitted in a first slot. The N TCI states are activated at a start of a second slot. The second slot starts T slots after the first slot.

In various embodiments, the UE partitions the N TCI states into M sub-groups of TCI states. The second channel indicates the M sub-groups and an activation time for each of the M sub-groups.

In various embodiments, the UE determines and activates M TCI states from the one or more lists of TCI states and transmits a third channel. The third channel signals the M TCI states. The third channel includes two parts, a first part that signals a value M and a second part that indicates the M TCI states as a combinatorial index.

In various embodiments, the UE determines first M TCI states from the N TCI states to deactivate, determines and activates second M TCI states from the one or more lists of TCI states, and transmits a third channel. The third channel includes a first and a second part. The first part signals a value M. The second part signals the first M TCI states and the second M TCI states.

In various embodiments, the UE receives a third channel signaling M indicated TCI states that are used for reception or transmission, determines first M1 TCI states from the N TCI states to replace second M1 TCI states from the M TCI states, and transmits a fourth channel signaling M1, the first M1 TCI states, and the second M1 TCI states. In some examples, the UE receives a fifth channel that is a PDCCH carrying a DCI format and applies the first M1 TCI states at a start of a time slot that begins a time T after an end of the fifth channel.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information related to one or more lists of transmission configuration indicator (TCI) states,
receive a list of TCI state activation times, and
receive a first channel activating N TCI states from the one or more lists of TCI states, wherein N≥1, and
a processor operably coupled to the transceiver, the processor configured to determine one or more activation times for the N TCI states,
wherein the transceiver is further configured to transmit a second channel in response to the first channel, wherein the second channel signals the one or more activation times for the N TCI states.

2. The UE of claim 1, wherein:
the one or more activation times is one activation time,
the one activation time for the N TCI states is T slots,
the second channel is transmitted in a first slot,
the N TCI states are activated at a start of a second slot, and
the second slot starts T slots after the first slot.

3. The UE of claim 1, wherein:
the processor is further configured to partition the N TCI states into M sub-groups of TCI states, and
the second channel indicates the M sub-groups and M activation times for the M sub-groups, respectively.

4. The UE of claim 1, wherein:
the processor is further configured to determine and activate M TCI states from the one or more lists of TCI states,
the transceiver is further configured to transmit a third channel,
the third channel signals the M TCI states, and
the third channel includes two parts, a first part that signals a value M and a second part that indicates the M TCI states as a combinatorial index.

5. The UE of claim 1, wherein:
the processor is further configured to:
determine first M TCI states from the N TCI states to deactivate, and
determine and activate second M TCI states from the one or more lists of TCI states,
the transceiver is further configured to transmit a third channel,
the third channel includes a first and a second part,
the first part signals a value M, and
the second part signals the first M TCI states and the second M TCI states.

6. The UE of claim 1, wherein:
the transceiver is further configured to receive a third channel signaling M indicated TCI states,
the M indicated TCI states are used for reception or transmission,
the processor is further configured to determine first M1 TCI states from the N TCI states to replace second M1 TCI states from the M TCI states, and
the transceiver is further configured to transmit a fourth channel signaling M1, the first M1 TCI states, and the second M1 TCI states.

7. The UE of claim 6, wherein:
the transceiver is further configured to receive a fifth channel,
the fifth channel is a physical downlink control channel (PDCCH) carrying a downlink control information (DCI) format, and
the processor is further configured to apply the first M1 TCI states at a start of a time slot that begins a time T after an end of the fifth channel.

8. A base station (BS), comprising:
a processor; and
a transceiver operably coupled to the processor, the transceiver configured to:
transmit first information related to one or more lists of transmission configuration indicator (TCI) states,
transmit a list of TCI state activation times,
transmit a first channel activating N TCI states from the one or more lists of TCI states, wherein N≥1, and
receive a second channel in response to the first channel, wherein the second channel signals one or more activation times for the N TCI states.

9. The BS of claim 8, wherein:
the one or more activation times is one activation time,
the one activation time for the N TCI states is T slots,
the second channel is transmitted in a first slot,
the N TCI states are activated at a start of a second slot, and
the second slot starts T slots after the first slot.

10. The BS of claim 8, wherein the second channel indicates M sub-groups and M activation times for the M sub-groups, respectively.

11. The BS of claim 8, wherein:
the transceiver is further configured to receive a third channel,
the third channel signals M TCI states,
the M TCI states are from the one or more lists,
the M TCI states are being activated, and
the third channel includes two parts, a first part that signals a value M and a second part that indicates the M TCI states as a combinatorial index.

12. The BS of claim 8, wherein:
the transceiver is further configured to receive a third channel,
the third channel includes a first and a second part,
the first part signals a value M,
the second part signals first M TCI states and second M TCI states,
the first M TCI states, from the N TCI states, are to be deactivated, and
the second M TCI states, from the one or more lists of TCI states, are to be activated.

13. The BS of claim 8, wherein:
the transceiver is further configured to transmit a third channel signaling M indicated TCI states,
the M indicated TCI states are used for transmission or reception,
the transceiver is further configured to receive a fourth channel signaling a value M1, first M1 TCI states from the N TCI states, and second M1 TCI states from the M TCI states, and
the first M1 TCI states are to replace the second M1 TCI states.

14. The BS of claim 13, wherein:
the transceiver is further configured to transmit a fifth channel,
the fifth channel is a physical downlink control channel (PDCCH) carrying a downlink control information (DCI) format, and
the processor is further configured to apply first M1 TCI states at a start of a time slot that begins a time T after an end of the fifth channel.

15. A method of operating a user equipment (UE), the method comprising:
receiving first information related to one or more lists of transmission configuration indicator (TCI) states;
receiving a list of TCI state activation times;
receiving a first channel activating N TCI states from the one or more lists of TCI states, wherein N≥1;
determining one or more activation times for the N TCI states; and
transmitting a second channel in response to the first channel, wherein the second channel signals the one or more activation times for the N TCI states.

16. The method of claim 15, wherein:
the one or more activation times is one activation time,
the one activation time for the N TCI states is T slots,
the second channel is transmitted in a first slot,
the N TCI states are activated at a start of a second slot, and
the second slot starts T slots after the first slot.

17. The method of claim 15, wherein:
the method further comprises partitioning the N TCI states into M sub-groups of TCI states, and
the second channel indicates the M sub-groups and M activation times for the M sub-groups, respectively.

18. The method of claim 15, further comprising:
determining and activating M TCI states from the one or more lists of TCI states; and
transmitting a third channel, wherein:
the third channel signals the M TCI states, and
the third channel includes two parts, a first part that signals a value M and a second part that indicates the M TCI states as a combinatorial index.

19. The method of claim 15, further comprising:
determining first M TCI states from the N TCI states to deactivate;
determining and activating second M TCI states from the one or more lists of TCI states; and
transmitting a third channel, wherein:
the third channel includes a first and a second part,
the first part signals a value M, and
the second part signals the first M TCI states and the second M TCI states.

20. The method of claim 15, further comprising:
receiving a third channel signaling M indicated TCI states, wherein the M indicated TCI states are used for reception or transmission;
determining first M1 TCI states from the N TCI states to replace second M1 TCI states from the M TCI states;
transmitting a fourth channel signaling M1, the first M1 TCI states, and the second M1 TCI states;
receiving a fifth channel, wherein the fifth channel is a physical downlink control channel (PDCCH) carrying a downlink control information (DCI) format; and
applying the first M1 TCI states at a start of a time slot that begins a time T after an end of the fifth channel.
